(19) United States
(12) Patent Application Publication
(10) Pub. No.: US 2008/0162287 A1
(43) Pub. Date: Jul. 3, 2008

(54) Method and system for ad-rotation and talent agencies allowing talent to protect and profit from talent and content

(75) Inventor: Elliot McGucken, Malibu, CA (US)

Correspondence Address: DR. ELLIOT MCGUCKEN, #971, 23852 Pacific Coast Highway, MALIBU, CA, 90265, US

(73) Assignee: ELLIOT MCGUCKEN, MALIBU, CA (US)

(21) Appl. No.: 12/006,117

(22) Filed: Dec. 30, 2007

Related U.S. Application Data
(60) Provisional application No. 60/877,761, filed on Dec. 30, 2006.

(51) Int. Cl. G06Q 30/00

(52) U.S. Cl. 705/14; 705/1; 705/27

(57) ABSTRACT

The present invention pertains to a talent agency that allows the talent to profit via sales of products, affiliate relationships, and ads which may be served via a simple, tiered banner-rotation system. The novel talent agency will allow the talent to protect and profit from their content and profiles and partake in promoting and selling branded merchandise. While online and offline talent agencies abound, sometimes built upon social networks or electronic databases or internet communities, none of them allow the talent to profit in the manners disclosed herein, via defining the rights to their content, including videos, pictures, music, and more, and/or selling ads, and/or promoting and selling merchandise, which the talent may actively wear and promote in their profiles and media. None of the talent agencies provide the talent with The 45 Revolver nor direct access to a full suite and spectrum of rights-defining, rights-protection/defining, watermarking, and DRM tools.

### FIELD OF THE INVENTION

The present invention relates generally to online business methods, and more specifically to a method for implementing an online talent agency whereby actors and actresses, models, musicians, filmmakers, artists and other forms of talent can have their talent and digital properties made available to the public and those who seek talent, and wherein the talent can immediately protect and profit from their digital assets in a plurality of manners. Unlike other talent agencies and databases defined in the prior and current art, this novel form of a talent agency affords multiple opportunities to both protect and profit from one's content.

The present invention is dedicated to all the talent throughout the ages—all the poets and prophets—who were ever killed by the Scribes and Pharisees, only to have their wisdom and creations institutionalized by the children of the Scribes and Pharisees—the scientists of the letter of the law who kill its spirit—so that the children of yesteryear's Scribes and Pharisees might be able to kill their very own poets and prophets, and institutionalize their wisdom. And so it goes, or so it went, until the founding of the United States, where we were given a Constitution which granted all the freedom of speech, the freedom of religion, and the right to bear arms—a Constitution that as the Founding Fathers noted was penned for a moral people who lived by the Biblical code handed down by Moses and Jesus, which proclaims Thou Shalt Not Murder, and Thou Shalt Not Steal. The present invention allows the talent to prevent others—the Scribes and Pharisees—from stealing the fruits of their labor and natural wealth of the artist's and creator's talent.

Even after DRM, rooted in Constitutional and Biblical values, has been destroyed, along with Epic story, the music and film industries which once produced Epics such as Cecil B. Demille's The Ten Commandments, the family, fatherhood, motherhood, and childhood; after reality TV has replaced the Epic Story and the Classic Western, after every classic has been remade in the pomo-hipster-producer's image—after every last dollar has been deflated by the printing of ten thousand more—after it appears that the Western Soul has for once and all been defeated, as the words of Moses are torn down from every courthouse and replaced with feminist art, these novel innovations and inventions shall rise like a Phoenix from the ashes of the pomo-hipster MBA/lawyer subprime-hedge-fund-hyper short-term profiteer destruction of honor and integrity; and their failed assault on Eternity. For in the third act of Western Culture, that man with no name, that man of infinite suffering and woe, that man who was abandoned by kings and kicked by beggars and supposed dead by his people, that man who has walked on down through hell, that man rides back into town, alone, armed with his 45 Revolver, to render God's Word, to render Justice, to make Ideals Real via Action.

Digital content is immortal, and as it are the pictures, songs, profiles, reels, video clips, art, photography, and creativity which lend talent databases their value and brands, those talent databases and talent agencies which better award the talent with novel forms of financial gain and enhanced commercial potentials will over time become better talent agencies. Wherever the talent can protect and profit form their content in novel and enhanced and improved manners, the free market will ensure that such locales, as described in this present invention, will become favorite destinations for the talent.

The present invention is based on Dr. Elliot McGucken's extensive research into the realm of Digital rights Management and Intellectual Property Law. Dr. E has spoken at the Harvard Law School's OSCOM, and he has appeared on panels devoted to IP including the Panel Discussion at the UNC-Chapel Hill School of Law The Law School panel is chaired by Laura Gasaway of UNC Law with John Whealan Deputy General Counsel for Intellectual Property Law & Solicitor USPTO, Marybeth Peters U.S. Register of Copyrights, Arti Rai Duke Law School, and Dr. Elliot McGucken ArtsEntrepreneurship.com at UNC-CH. Dr. E's dissertation on an artificial retina for the blind won a Merrill Lynch Innovations Award. The Wall Street Journal reported, The Wall Street Journal wrote: Elliot McGucken decided to straddle the two worlds. After he earned a doctoral degree in physics/electrical engineering, Dr. McGucken considered himself “fortunate” to get a teaching job at Davidson College in Davidson, N.C., and to continue his engineering research. But then, last year, he won the Innovation Grants Competition sponsored by Merrill Lynch Forum (for an artificial retina chipset for the blind), the virtual think tank of the financial-services company. The contest, now in its second year, gives out $150,000 in prizes for Ph.D.s, and their institutions, who find commercial applications for their research. After winning the contest, he got to tour the New York Stock Exchange. Dr. McGucken caught the entrepreneurial bug. Eventually, he launched jollyroger.com, an Internet company devoted to his longtime passions: writing and classical literature.—The Wall Street Journal, Academics Have to Do Their Own Homework On Job Opportunities By By Hal Lancaster, The Wall Street Journal. Regarding the class Dr. E created for artists, ARTISTIC ENTREPRENEURSHIP & TECHNOLOGY, Teresea Ciulla of Entrepreneur Magazine blogs, “Can you actually make your passion your profession? According to Dr. Elliot McGucken, a professor at the University of North Carolina, Chapel Hill (and now Pepperdine University), who's teaching the university's first “Artistic Entrepreneurship & Technology 101” class, the answer just may be yes. McGucken's class, which is comprised of a group of 45 students majoring in law, business, art, computer science, journalism and music, focuses on teaching students about creating value over just making money, about letting their higher ideals guide the bottom line. After all, as McGucken says, “Successful companies aren't successful because they make money—they're successful because they create value.” Class projects range from a classical music video to a hip hop curriculum and textbook to an online art gallery to a freshman's record label that's signed more than ten bands to a social network being programmed by three computer science majors. Students are seeing that to the degree they succeed in creating useful art and ventures, they'll be able to support their passions with a profitable business. And isn't that what we're all really striving for? To find an excitement in our work in order to beat back the dullness of the typical 9-to-5 routine? Looks like McGucken's found a way to inspire a new generation of artistically minded entrepreneurs to follow their passions—and make a living.”

The present invention was created in the interest of exalting and serving the indie artist and creator such as Eminem and Toby Keith and Avril Lavigne and Kid Rock and Einstein and Galileo and Da Vinci and 50 Cent—the true creators of enduring wealth, though 50 could perhaps take a higher road now and then, but hey, it's cool. I'm a huge fan of 50 and I know he grew up in a rough neighborhood and all, and in many ways his art is his way of dealing with it—I think it comes from his heart, which is why he's good. But he seems honest in his songs, and he talks about walking through hell to get to heaven, “I gotta make it to heaven, for going through hell. Gotta make it to heaven, gotta make it to heaven, I gotta make it to heaven, for going through hell, Gotta make it to heaven I hope I make it to heaven.” Fifty Cent prays to God and begs for mercy, “Lord I don't cry no more, Don't look to the sky no more, Have mercy on me, Have mercy on my soul, Somewhere my heart turned cold, Have mercy on many men, Many, many, many, many men, Wish death upon me.”

I'm a huge fan of Kid Rock/50 Cent/Eminem, and I love it how they're all standing up to iTunes/Apple/labels and fighting for artist's rights—the “45 Revolver” inventions shall seek to serve them as best as possible. The technology could use a bit of their soul and spirit. 50 Cent is a natural-born artist and he, like all artists, deserves technology that recognizes and celebrates his God-given right to protect and profit from his content. But right now there are too many soulless pomo-hipsters posin' as pimps ‘n’ hos, getting MBAs and law degrees in the art of wealth-transfer, transferring wealth away from the common worker and saver and artist to da hedge funds via the printing of money, hype and frontin' and taxin' and killing off of DRM and attacking property rights and whatnot. Eminem and 50 both grew up in single-parent households, courtesy of the feminist movement and most-profitable divorce industry created by lawyers and haters jealous of Moses and Jesus—hatin' on all the poets and prophets, from Homer on down; as they have found a path to power inspired by da fake economists and dismal social scientists who profit from da destruction of the family and the growth of da State, yo.

50 Cent reports that filesharing is destroying the infrastructure which once helped artists, though some could argue the infrastructure had been destroyed via postmodern MBAs and lawyers when they got their hands on the aesthetics; before they ever got their hands on the filesharing and DRM-free music which profits the technocrat aggregators far more than the artist and individual creator. 50 Cent finishes up: “The main problem is that the artists are not getting as much help developing as before file-sharing. They are now learning to peddle ringtones, not records” he said. “They don't understand the value of a perfect piece of art.””—http://www.thesecondpress.com/blog/2007/12/09/50-cent-file-sharing-doesn%E2%80%99t-hurt-artists-industry-should-adapt/ It should be noted that 50 Cent came up through an era whence shoplifting albums and records and stealing CDs and music was illegal. Indeed the record companies screwed the artists even then, but now the snarky snark hedge-fund telecom “information wants to be free” lawyers and MBAs are perfecting the crime, by criminalizing the creator for wanting to protect and profit from their music, videos and songs. New networks, DRM-based innovations, and talent agencies shall arise to support the creator and serve the artist over the backroom MBA/lawyer encouraging filesharing as it sells more ipods/high-speed connections/disk drives/blank cds/blank dvds/youtube views/devices/computers. And the artists shall now provide the soul for free, as 50 Cent repeats the new corporate mantra from on high. It has ever been a human instinct to cut down the ladders by which one climbed on up, and one sees it all the time amongst college administrators who rose via handshakes and honor and science, only to hire pomo hipsters and feminists who replace honor and science with politics. A commenter points out that “50 is saying this because after years of marketing off the success of his album sales he now has to switch his angle to appear “tech savvy” since his last album flopped. The last 4 G Unit projects have failed to reach Gold status so he know in order to stay relevant he has to now support the same thing that finished him off but he's ok with it because he already made his millions prior to “the collapse”. When 50 can actually come with some SOLUTIONS to the lack of official revenue streams for the artists (especially the new ones) then you can come with all that “he's so smart”.”—Mitch Reisendorf, http://www.techcrunch.com/2007/12/08/50-cent-file-sharing-doesn%E2%80%99t-hurt-artists/#comment-1825491 This present invention, as well as all the 45 Revolver inventions, offers a solution for 50 and Eminem. Meanwhile, the snarky lawyers and MBAs who once ripped off artists and consumers from record labels slide on over to iTunes and youTube, where they campaign and legislate against DRM and paying artists anything at all. Such are the end results of an empire in decline, whence the elite discovered it is simply more profitable to print money than work for it—this is the original sin against art, and all the snarky-MBAs and hired gun pomo-hipsters know not what they do—pawns caught up in the destruction of the Western Soul and Civilization. But yet—I predict that Odysseus will return on home and clean house of all these false suitors, and that Moses will come on down from that Mountain, and that the temple shall fall, and Jesus Christ shall rebuild it.

Have faith my friends, for as Socrates said, all wealth comes from virtue, and virtue does not come from wealth, nor government, nor taxes, nor corporations and bureaucracy. He was put to death for this, of course, for the Truth is the ultimate crime against the State lawyers and MBAs of any era. Thank goodness for those first two amendments, which are yet of great use, should they only be read in the context of the great books and classics.

In one embodiment, the present invention would share revenues as follows: Every user with a presence on the site is associated with an ad code. When a browser comes into a network via a certain node, the user of that node has all three ad spaces associated with the ad code—the top or header ad code, the sidebar or skyscraper adcode, and the footer adcode. When the browser follows a link to a user's friend, which defines a new node, the original node's ad code is attached to the the skyscraper ad to the side and the footer ad at the bottom. When the browser follows a further link to node3, node2's ad code is associated with the side skyscraper ad, and node1's ad code is associated with the footer ad, while node3's ad code is associated with the prominent header as. So it is that ads might be displayed, and ad revenue might be shared, in a simple and natural manner according to the structure underlying social network.

The ad-rotation system of the present invention would allow a natural means for compensating the talent due to a simple, underlying algorithm; which would foster a novel business model. The nodes, or profiles, which received the most exterior traffic would profit the most as all ads would always be theirs. Also, the nodes which are one link deep in the network would profit well, so that the friends on the most prominent profiles would be justly rewarded for their friendships. And so it goes, as this novel ad-rotation system would ensure revenue share in a simple manner that yet efficiently and effectively is proportional to the inherent structure of the underlying network and the traffic generated, thusly ensuring the greatest rewards for the greatest nodes and thusly reward the greatest talent. Such a system could also be linked to affiliate ad codes and an advertising/sales system for merchandise, wherein the ads would link directly to an ecommerce presence owned and operated by the talent agency, whereupon the talent may be compensated for sales of merchandise they drove, in proportion to the prominence of the ads and the ownership of the ads, be they the top header banner, the side skyscraper banner, or the bottom footer banner. Many other banners and rotation systems for talent databases may be developed in the spirit of the present invention, wherein the banners could be served by and link to external ad systems, internal ad systems, external commerce systems, or internal commerce systems. The spirit of the present invention is to allow artists and talent to protect and profit from their profiles and artistic creations and reels and photography and music inventions and innovations in a maximal manner.

### OBJECTS AND ADVANTAGES OF THE INVENTION

This invention pertains to a method and system for allowing the talent to immediately start profiting from their talent, by defining their rights via access to a full suite of DRM and watermarking tools, and/or participating in revenue generated via advertising sales sold about their content and profiles, and/or displaying their own ads and merchandise alongside their profiles and content, and/or selling ads and merchandise through a system operated by the talent agency, whereby the talent can partake in profits generated via a tiered system which breaks down and assigns percentages for the revenue sharing. Furthermore, the talent will be able to syndicate and sell their content throughout other portals on the web. Furthermore, the talent can profit by participating in a novel banner-rotating or advertisement-rotating network hitherto unseen upon this earth, which simply and naturally rewards the talent in proportion to the natural structure of the underlying network.

In an embodiment of the present invention, the talent may be allowed to partake in selling and promoting a fashion line. Imagine if Ralph Lauren®™ or Nike®™ or Rolex®™ or some other brand and a talent agency or database combined forces online, where all the talent could participate in modeling shirts and shoes and clothes and watches; and receive revenue proportional to the sales. So too could a fashion startup such as 45 SURF™ launch a talent agency wherein the talent partook in the selling of the clothes and advertising, also partaking in revenue generated via such sales. And with the ease of digital video, the talent could create and partake in advertising sketches and skits and comedies that promoted the brand, or had product placement for the brand, again gaining revenues. A talent database such as modelmayhem.com, or 1modelplace.com, or lacasting.com, or any of the others could benefit from such an innovation or combination of hitherto distinct elements. The system could be set up so that models would have to apply to be able to model certain brands or certain levels of the brand, so that only the best models would represent the brand. Or perhaps all would be allowed to represent the brand, or perhaps all would be allowed to model the brand, but they would be paid in different percentages of revenue share, proportional to their degree of talent. Multiple combinations and novel systems for allowing the talent to profit from their talent are celebrated in this present invention.

This present invention is different from other online talent agencies in that it allows the talent to protect and profit from their creations, and make novel monetary and financial gains from their creations. It lets them call the union's and youtube's bluff, and all the new-media companies built upon old-media conglomerate, leftist, Godless mentalities, and start protecting and profiting from their content, while participating in ad and merchandise sales. For the Creator is given high accord in both the Bible and the Declaration of Independence, which states, “We hold these truths to be self-evident, that all men are created equal, that they are endowed by their Creator with certain unalienable Rights, that among these are Life, Liberty and the pursuit of Happiness.—That to secure these rights, Governments are instituted among Men, deriving their just powers from the consent of the governed,—That whenever any Form of Government becomes destructive of these ends, it is the Right of the People to alter or to abolish it, and to institute new Government, laying its foundation on such principles and organizing its powers in such form, as to them shall seem most likely to effect their Safety and Happiness. Prudence, indeed, will dictate that Governments long established should not be changed for light and transient causes; and accordingly all experience hath shewn that mankind are more disposed to suffer, while evils are sufferable than to right themselves by abolishing the forms to which they are accustomed. But when a long train of abuses and usurpations, pursuing invariably the same Object evinces a design to reduce them under absolute Despotism, it is their right, it is their duty, to throw off such Government, and to provide new Guards for their future security.—Such has been the patient sufferance of these Colonies; and such is now the necessity which constrains them to alter their former Systems of Government. The history of the present King of Great Britain is a history of repeated injuries and usurpations, all having in direct object the establishment of an absolute Tyranny over these States. To prove this, let Facts be submitted to a candid world.”

This present invention shall afford the talent the opportunity to foster a renaissance in the culture rooted in classical idealism and epic story, and the classical idealism shall in turn support novel inventions such as the present one, which celebrate the artist's right to own what they do, to protect and profit from their content. And the artists and creators—the talent—shall be able to produce and protect, to finance and foster—epic art beyond the snarky, dervish grasp of the vast, soulless studios, and the soul of the art shall find its way into tomorrow's technology. For the iPod and iTunes, which were but platforms for Steven Jobs to abolish artist and creator rights, shall be replaced by new devices which allow multiple DRMs to be used, and multiple online music and video and content stores to be accessed. For make no mistake, Steven Jobs wants to abolish DRM—the means by which artists protect and profit from their creations, but Steven Jobs also DRMd his DRM, keeping it a proprietary standard and never sharing nor putting his DRM specs nor software nor technology out on the web for others to use. Jobs is in tight with the vast, soulless corporations, and as Nietzsche said, when a man stares long enough into the void, eventually it looks back into him. Captain Ahab went after Moby Dick, but eventually the White Whale turned on him, and Moby Dick ends with, “A sky-hawk that tauntingly had followed the main-truck downwards from its natural home among the stars, pecking at the flag, and incommoding Tashtego there; this bird now chanced to intercept its broad fluttering wing between the hammer and the wood; and simultaneously feeling that etherial thrill, the submerged savage beneath, in his death-gasp, kept his hammer frozen there; and so the bird of heaven, with archangelic shrieks, and his imperial beak thrust upwards, and his whole captive form folded in the flag of Ahab, went down with his ship, which, like Satan, would not sink to hell till she had dragged a living part of heaven along with her, and helmeted herself with it.” For make no mistake—Steve Jobs is not against DRM—he is only against DRM for indie creators and artists, as shown in this article: http://www.macobserver.com/article/2007/12/26.7.shtml: “Apple, Inc. has filed for a patent in the U.S. for a Digital Rights Management (DRM) system for controlling where software runs. The method described in the application is one that allows for the injection of code into an application's run-time instruction stream that checks to see if the application is being run on a “specific hardware platform,” and then repeats that check to see if it is still being run on that authorized platform.”—http://www.macobserver.com/article/2007/12/26.7.shtml

Every single snarky-snark freetard who is against DRM for artists and creators uses it every day for themselves, as it protects their bank accounts and medical records and the software they write and profit from. They use locks on their cars and even Steven Jobs has locks on his Apple stores, so that you can't walk out with an iPod and iPhone without paying premium, before you pirate a bunch of songs and ripoff the artists who provide the reason for buying the iPod. Jobs et al would prefer to think that you purchase the iPod to place it in a shrine in your home and bow down before it and worship it, but in actuality, the soul of the iPod is the art—the music and videos—created by the talent.

Because giant corporations and the government can't yet legally make money from people downloading bank accounts and medical records (we hope), they have turned to the musicians and artists and creators to exploit, as creators create because they must. And the great thing is, as they kill property rights, they can amass the content, make profits on it while the individual creator cannot and is taught not too by state and corporate MBA officials who hire snarky-snark freetard hipsters as spokesmodels and fly them around and give them fancy meals, and then institute state arts bureaucracies where aging men pay peanuts to so-called artists to create so-called feminist art which is nothing but politics, and which offers a political litmus test—if you speak out against it, you will be forever banned, persecuted, and tormented by the old men's State machine. For the uncreative, soulless bureaucrat finds the desecration of art and the growth of government to be far more profitable to them than the act of creation; for their impotence has left them without any natural wealth of their own, and they must sack and tax the estates and creative works of others. Groupthink and tyranny have ever proven a most profitable industry for artistically impotent tyrants, and they exculpate themselves, washing their hands like Pontius Pilate, as they blame it on the faculty, each who gets a tiny little cut of the massive amount of billions upon billions printed every year, and augmented by the massive debts students incur, as the manufacturing of debt is a great way to won the property and labors of others, while sending women out in the workplace and putting their children in state and corporate-funded daycare, so as to better condition the children to detest the classical arts. It was genius to unite all the faculty of every university in the printing of money, for they train the students who go forth and manage hedge funds that hawk subrime loans which will someday become homes the bank owns or labor worked to pay off the ridiculous mortgage, and some run magazines and newspapers, who all agree—printing money is a most noble endeavor; and Dante had no idea what he was talking about. And too, as they must propagate the myth that the government is the source of wealth, as opposed to God and the Individual Innovator and Artist, the destruction of property rights allows them to criminalize the creator, as the act of creation is redefined as stealing from the State. The act of using DRM becomes a crime, as does the act of patenting a novel idea that would allow rugged indie artists and creators and talent to use DRM, and which would allow the talent to profit from their talent. There can be no greater affront to the talentless MBA/lawyer, and hell hath no fury like a woman scorned. There are more women in law school than men now, and women are generally for big government as if the guy buys her a meal and acts like a jerk, they don't mind getting screwed over, and the taxpayers get to support the jerk's kid, and for this reason Stephen Baskerville recommends against marriage, which has been destroyed by the practice of Family Law and snarky lawyers who seek to monetize all entities created via Tradition and Honor, who divide that which God has joined together so as to profit in the short term, and who fight foreign wars on foreign shores to export their destructive machine, who legalize killing the unborn, and legalize illegal immigration, as some Wall Street bureaucrat realized that it is more profitable to import labor than it is to take mothers out of the corporate marketplace and have them serve God and their husbands, in the raising of children; instead of banging and serving the random, soulless MBAs. In the same way that the government and corporations seek to divide talent from its natural, inherent reward so as to allow hedge funds and massive youtube corporations to profit, the government and corporations seek to separate children from parents, either before or after birth, as both systems are more profitable in the short term than having a mother honor God and her children by raising them. The “divorce regime” Baskerville reports on is actually far greater than just the family, as alluded to in C. S. Lewis's The Great Divorce. The “divorce regime” represents the divorce of the Western Soul from mankind, so as to enslave mankind to government, corporate, and State bureaucracies. And this present invention shall allow tomorrow's poets and profits to fight the great divorce, to lay claim to the fruits of their private property, and to exalt a cultural renaissance.

On his website, Stephen Baskerville writes, http://www.stephenbaskerville.net/ (keep in mind that “divorce regime” and “divorce” could also apply to the separation of the Western Soul from Mankind.) Baskerville writes, http://www.stephenbaskerville.net/

“The divorce regime is the most totalitarian institution ever to arise in the United States. Its operatives in the family courts and the social service agencies recognize no private sphere of life. “The power of family court judges is almost unlimited,” according to Judge Robert Page of the New Jersey family court. “Social workers are perceived to have nearly unlimited power,” a San Diego Grand Jury concludes. “Absolute power corrupts absolutely. Total immunity [enjoyed by social workers] is absolute power.”

“The divorce regime is responsible for much more than “ugly divorces,” “nasty custody battles,” and other cliches. It is the most serious perpetrator of human and constitutional rights violations in America today. Because it strikes the most basic institution of any civilization—the family—the divorce regime is a threat not only to social order but to civil freedom. It is also almost completely unopposed. No political party and no politicians question it. No journalists investigate it in any depth. A few attorneys have spoken out, but they are eventually suspended or disbarred. Some academics have written about it, but they soon stop. No human rights or civil liberties groups challenge it, and some positively support it. Very few “pro-family” lobbies question it. This is because the divorce regime operates through money, political power, and fear.

“The divorce regime is much more serious than simply “unfairness” or “gender bias” against fathers in custody proceedings. It is the government's machine for destroying the principal check on its power—the family—and criminalizing its main rival: fathers. The most basic human and constitutional rights are routinely violated in America's family courts. The lives of children and parents are in serious danger once they are, as the phrase goes, taken into “custody.” Systemic conflicts-of-interest among government and private officials charged with child custody, child support, child protection, and connected matters have created a witch hunt against plainly innocent citizens.

“The terror of the divorce regime is not a future possibility; it is a present reality. The following methods are currently employed by family courts and other government agents. These practices are now widespread in America:

“mass incarcerations without trial or charge

“forced confessions

“children forcibly separated from parents who are under no suspicion of legal wrongdoing and parents stripped of the care, custody, and companionship of their children without explanation

“government agents entering the homes, demanding and examining private papers and personal effects, and seizing the property of citizens who are under no suspicion of legal wrongdoing

“official court records, including hearing tapes and transcripts, doctored and falsified with the knowledge of court officials and evidence fabricated against the innocent

“defendants denied the constitutional right to face their accusers

“bureaucratic police authorized to issue subpoenas and arrest warrants against parents, with no hearing and contrary to due process of law

“special courts created specifically to process parents for political offenses

“forced labor facilities created specifically for parents

“children instructed to hate their parents with the backing of government officials

“children forced by government officials to act as informers against their parents

“children abused and killed with the backing of government officials

“knowingly false allegations, for which no evidence is presented, accepted as fact without proof, overturning the presumption of innocence, and not punished when demonstrated to be untrue

“parents ordered by government officials to separate from their spouses, on pain of losing their children

“parents forced to pay the private fees of court officials they have not hired and whose services they have not sought or used, on pain of incarceration

“parents suspected of no legal wrongdoing punitively stripped of their property and income, sometimes at gunpoint, and reduced to penury

“government officials using the mass media to vilify private American citizens, and political leaders using their offices as platforms to verbally attack private American citizens, who have no right of reply or opportunity to defend themselves

“parents jailed without trial reportedly beaten, in at least one case fatally, and denied medical attention while in police custody.

“I have made these charges in some of the most reputable publications in the English language. They have never been refuted. Yet neither have they been corrected or even addressed by public officials, the media, or academics.”

“This site will tell you the truth about the divorce regime. It contains virtually all my published works—over 70 articles—on the fatherhood crisis and the corruption of the divorce industry (except book reviews and radio commentaries). For better or worse, these are the most strongly worded writings to appear on this subject in mainstream publications.”

“I am heavily indebted for the many letters, stories, documents, clippings, studies, citations, books, e-mail communications, and telephone calls—collected and sent to me by hundreds, perhaps thousands of people. It is not possible to name all these people, and many prefer not to be named.

Stephen Baskerville

March 2007”—from http://www.stephenbaskerville.net/

Again, the great divorce is the divorce of the Western Soul and the exalted spirit from mankind, and its replacement with a state and government bureaucracy, and it can be extrapolated to the separation of the talent and the natural profits of their talent. Just as Baskerville writes that “children (are) forcibly separated from parents who are under no suspicion of legal wrongdoing and parents stripped of the care, custody, and companionship of their children without explanation,” so too are creators separated from their creations.

The present invention allows the talent to own and capitalize on their talent. Every traditional form of honor and integrity has been ironized, commoditized, and commercialized by the snarky lawyers and soulless MBAs, as they print the money they lend you when you take out massive amounts of loans to join the elite MBA/JD wealth-transfer club, jockeying for a small, insignificant position just a tiny bit closer to the money pump, or when you sign on that subprime loan, while they're betting (encouraged by Nobel Laureate economists and brilliant mathematicians) that someday the house will be theirs, after you have spent a few years toiling under the debt and sending them checks represented by real work and labor for the debt that is greater than the value of your home. “Ha ha!” they say when you take your marriage vows seriously, and your wife takes half your assets in a snarky “no fault” divorce, supporting her right to bang everyone the oppressive institution of marriage prevented her from banging. “Ha ha!” they say when youtube gets sold for $1.6 billion dollars and all the writers and creators whose words and music and art and film made youtube receive not a penny. “Ha! Ha!” The writer's strike is funny in that the studios fired writers long ago, when they replaced rugged, epic story with degraded reality TV, remakes, materialistic, corporate-feminist daytime talk shows. And the writers want more internet residuals? I saw a video on youtube, created by a writer, about how the writers want more internet residuals. And guess what, the writer, who is on strike demanding more internet residuals, didn't get paid for the youtube video. “Ha ha!” And it turns out Steven Jobs is against DRM for the artists. “Ha ha!” Isn't it ironic, don't you think? But his commodity-reversal is but a momentary quirk, as the individual artist's soul is not the commodity—the technology is the commodity, as are all bureaucrats who oppose fundamental, natural rights—they are a dime a dozen, and they do well in times of money printing and Empires; but artists, inventors, and creators—the Poets and Prophets—rule eternity.

It is well-known that corporate and government bureaucracies are pretty much one and the same, as all their lawyers attend the same elite schools and grind at the college clubs until three or four become one, and their chief purpose is to keep grinding away as they position themselves as close as possible to the Federal Reserve's money pump which celebrates the violation of the US Constitution each and every day by printing money, and they skim of a few million here and there to hold Galas where they grind some more and celebrate desecrating and destroying all fundamental rights granted and gifted by God, including marriage, motherhood, fatherhood, childhood, Truth, and property rights—and make no mistake—there is no greater Property than Truth and the Western Soul, which is why the pomo-hipsters attack it first, with their lattes, their LSAT case studies of opinions made by snarktard people with snarky opinions instead of the Truth of the Great Books and Classics. I have not the time to fully elaborate here for snarky, soulless lawyers and MBAs manufactured to serve the corporate bureaucracies, and the burgeoning state created by the Fed's money pump, but I would highly recommend reading The Bible, The United States Constitution, The Declaration of Independence, The Road to Serfdom, Homer's Odyssey, Bogle's Battle for The Soul of Capitalism, Smith's The Wealth of Nations and Theory of Moral Sentiments, my novel Autumn Rangers in which the protagonist must save the soul of civilization by saving Autumn's soul and uploading it into APRIL which will also herald a new age of video games with female characters with deep souls and thus finally video games with deep souls, and Socrates' Apology. For the true value of this invention can only be realized in the exalted context of the great books and classics, which celebrate our Natural Rights via the Moral Premise. The prophets and poets have ever been stoned and put to death by the scribes and Pharisees, and that is why our Founding Fathers left us with the first two amendments, for the freedom of speech is soon rendered useless without the complimentary right to bear arms, and it is why our Founding Fathers recognized God's gift of intellectual property. So it is that every creator and artist shall be given a 45 Revolver, which Charlton Heston stated would only ever be taken “from my cold dead hands.” Sure Benjamin Franklin never patented his Franklin Stove nor other inventions—he gave them freely. But that is the brave secret—the gave them freely—the state apparatus did not take them away and rob Peter to pay Paul, while pocketing the majority for themselves. Franklin gave them freely.

The day will soon be here when talent can begin protecting and profiting from their talent the moment they upload it online. An online talent database, which affords the talent a full suite of tools for digital rights management (DRM), watermarking, and syndicating, managing, and selling content and advertising, while also profiting from shares in merchandise and ad sales, will stand head and shoulders above the current talent databases. A tiered system could be created, wherein the talent would be afforded to the opportunity to generate revenue based on a tiered structure of ad sales and merchandise sales. For instance, one could envision a talent database married to a commerce system selling shirts, wherein the A-list talent would be afforded the opportunity to sell the gold-label shirts and receive a percentage of the profits, while the B-list and perhaps C-list talent could only sell the regular shirts, while receiving a percentage share of the profits. Also, A-list talent might be afforded a greater percentage of commissions, while the B-list talent would receive less commissions. The same structure could be imagined with advertising sales replacing the sales of merchandise, wherein the A-list talent may be able to sell grade-A advertising, while the B-list talent would only be able to sell grade-B advertising. The shirts and advertising in the above embodiments of the present invention could be replaced with any merchandise, advertising, or any entity that generates revenue or profits or makes money.

The present invention solves the issues of the writer's strike by allowing true writers and artists to bypass the dumbed-down, snarky MBA producers and their fancy lawyers who detest true art and epic story as it gets in the way of all their wealth-transfer machinations. The funniest thing about the writer's strike is that the Studios fired the writer's long ago, as no longer are novels with Epic, modern heroes in fashion. Sure, now and then we are allowed to witness courage, bravery, marriage, and true love in epics such as Lord of The Rings, Braveheart, The Matrix, and The Chronicles of Narnia, but never are these ideals allowed to grace the silver screen of contemporary times, as such ideals remind us of God, and God gave Moses The Ten Commandments, one of which states “Thou Shalt Not Steal,” which gets in the way of billion-dollar corporations hiring million dollar buyers and sellers of the law and obliterating digital rights management. The snarky lawyers and postmodern wealth-transfer classes have found that the ten commandments get in the way of profits, as they profit from the destruction of the family and the divorce industry, as well as from theft via the printing of money and the obliteration of digital rights management which allows them access to every bit of data and information ever created by mankind. You sill see that they have launched an all-out assault against The Declaration of Independence and The Constitution, as well as the Bible and the Ten Commandments, resulting in the decline of the music industry, movies, films, epic storytelling, in-tact families; and the rise in child abuse, abortion, and illegal immigration to make up for it.

The Present Invention supports the Ten Commandments, which declare, Thou Shalt Not Steal, meaning that one shall not take the talent's profits, meaning that one shall provide the talent with a system and method for them to protect and profit from their talent, as this present invention does in a novel manner.

The Ten Commandments, which they have banned from our schools so as to deconstruct the children's souls and marry them to the bottom line of commerce regulated by government bankers who speak highly of a free market but then at the last second compromise it by printing money at their whim are as follows: The King James Version of the Bible—Ten Commandments KJV

I am the LORD thy God, which brought thee out of the land of Egypt, from the house of bondage.

7 Thou shalt have none other gods before me.

8 Thou shalt not make thee any graven image, or any likeness of any thing that is in heaven above, or that is in the earth beneath, or that is in the waters beneath the earth:

9 Thou shalt not bow down thyself unto them, nor serve them: for I the LORD thy God am a jealous God, visiting the iniquity of the fathers upon the children unto the third and fourth generation of them that hate me,

10 And shewing mercy unto thousands of them that love me and keep my commandments.

11 Thou shalt not take the name of the LORD thy God in vain: for the LORD will not hold him guiltless that taketh his name in vain.

12 Keep the sabbath day to sanctify it, as the LORD thy God hath commanded thee.

13 Six days thou shalt labour, and do all thy work:

14 But the seventh day is the sabbath of the LORD thy God: in it thou shalt not do any work, thou, nor thy son, nor thy daughter, nor thy manservant, nor thy maidservant, nor thine ox, nor thine ass, nor any of thy cattle, nor thy stranger that is within thy gates; that thy manservant and thy maidservant may rest as well as thou.

15 And remember that thou wast a servant in the land of Egypt, and that the LORD thy God brought thee out thence through a mighty hand and by a stretched out arm: therefore the LORD thy God commanded thee to keep the sabbath day.

16 Honour thy father and thy mother, as the LORD thy God hath commanded thee; that thy days may be prolonged, and that it may go well with thee, in the land which the LORD thy God giveth thee.

17 Thou shalt not kill.

18 Neither shalt thou commit adultery.

19 Neither shalt thou steal.

20 Neither shalt thou bear false witness against thy neighbour.

21 Neither shalt thou desire thy neighbour's wife, neither shalt thou covet thy neighbour's house, his field, or his manservant, or his maidservant, his ox, or his ass, or any thing that is thy neighbour's.

The present invention goes against the popular and prominent opinions of the modern-day experts, as the present invention agrees with Moses that “thou shalt not steal,” which means that those who create art—the individual talent—ought be compensated. The technology has fostered a new world where artists can distribute directly to the end consumer, and yet this has yet to be realized, as the tyrannical middlemen and their meddlesome lawyers are hungry for profits. The record companies largely cut the artists out of the profits, and as iTunes and youtube cut the artists out of the profits to an even greater extent, they are heralded as apt and great replacements by Lessig, Jobs, et al. When the artists and talent make nothing, and the device makers and lawyers make everything, then shall have the technology succeeded.

The present invention, along with all the other manifestations of the 45 Revolver, has arisen to grant the lion's share of the profits to the talent. The present invention has the soul of The founding Fathers, the Great Books, and the Classics, and it agrees with Homer—fair dealing leads to greater profit in the end.

Perhaps the present invention won't be realized for many years, as the haters are firmly entrenched. But I am an optimist, and they just simply cannot kill the immortal soul. A generation of artists and technologists shall arise who will endow the silicon with soul—the video games, the American woman, content distribution systems, and this—the 45 Talent Agency.

“I have sworn upon the alter of God, eternal hostility against every form of tyranny over the mind of man.”—Thomas Jefferson. The present invention, by allowing talent to protect and profit from their talent, to take ownership in their private property, serves the spirit of all classical economists, Adam Smith, and the Founding Fathers. The present invention, via DRM, will protect the creators' content from the grasp of giant amoral media companies which are at best only capable of doing no evil. For Einstein warned us: “The world is a dangerous place to live; not because of the people who are evil, but because of the people who don't do anything about it.” Edmund Burke agrees with, “The only thing necessary for the triumph of evil is for good men to do nothing.”

One of the funny things are the handful of millionaire artists, who came up through a system where shoplifting and theft were illegal, giving DRM the middle finger. Sure, they don't need DRM—the studios helped them achieve their name with great investments, but the little guy isn't going to make a lot of money posting free mp3s on myspace.com so that Rupert Murdoch can sell ads around them. No, a brand new talent agency is needed—one where the talent, the actors and actresses, can profit from ad sales, sell merchandise, and also find out about larger projects, while creating browsable profiles. My friend—a country singer—said she thought the whole Radio Head thing sucked. Andrew Keen has some insight on RadioHead, “And no. After all, Radiohead is essentially screwing the music business. What they would call “disintermediation” is actually putting music business people out of work. Jon Pareles' “middlemen” are real people with real jobs and real families. However much Radiohead might hate the “exploitative” labels, it's hard to see the real benefit here for the music business. If Radiohead had a real social conscience, they would start their own label, employ their own “middlemen”, and help build—rather than destroy—human infrastructure in a decimated industry. When the history books get written on the death of the recorded music industry at the turn of the 21st century, Radiohead's “In Rainbow” will represent one more futile and counterproductive strategy in (re)building the economic value of musical content.”.”—http://andrewkeen.typepad.com/

The present invention, via DRM, will protect the creator's content from the grasp of giant amoral media companies, vast networks of fanboy thieves and file sharers, and universities that encourage the decline of the family and the theft of cash via the printing of money, the demolition of digital rights management, the destruction of the family, and the growth of government and banking bureaucracies, whose ultimate goal is to transfer all the wealth to the elite few, and all the risk and turmoil to the honest worker. Ever since America shifted from manufacturing things to printing dollars, she has dedicated herself to creating the wealth-transfer class, filled with non-creative bureaucrats espousing feminist theories whose intent is the destruction of the family, the sacred father-child bond, the sacred mother-child bond, and the sacred God-man bond. But the only problem is that as Jefferson said, that same God who granted us life granted us liberty, and one cannot take one without taking the other. Jefferson also said, “God forbid we should ever be twenty years without such a rebellion. The people cannot be all, and always, well informed. The part which is wrong will be discontented, in proportion to the importance of the facts they misconceive. If they remain quiet under such misconceptions, it is lethargy, the forerunner of death to the public liberty. . . . And what country can preserve its liberties, if it's rulers are not warned from time to time, that this people preserve the spirit of resistance? Let them take arms. The remedy is to set them right as to the facts, pardon and pacify them. What signify a few lives lost in a century or two? The tree of liberty must be refreshed from time to time, with the blood of patriots and tyrants. It is its natural manure.”

Cowardly men posing as economists and bowing to feminists all for the sake of a few federally printed dollars thrown their way have destroyed the spirit and soul of the University, which has resulted in the destruction of the soul of capitalism and corporations. They were ingenious in latching onto and pumping up the feminist movement, picking on the fairer sex, and destroying their souls by having them sleep around starting as early as possible, as encouraged by all the shows aimed at young women, all the gangsta rap which commands them to grind and latch on to the material over the spiritual, and which has killed the Judeo-Christian heritage, enslaving all of entirety to the bottom line, whose only commandment is that all of entirety shall go into debt, as debt is how they create wealth; causing those to in debt to do real work, while those who print the money hold all the titles to their land and homes. Miss a couple payments, forget to read the fine, tricky print about how your mortgage will double, and because they printed money and you worked to buy a house, they get your house. The boomereaucracy is ingenious in that it enslaves the young to debt at early ages, handing them credit cards are charging massive fees for college and university tuition, where the lion's share goes to snarky administrators and the endowment. Warren Buffett wrote that hedge find are not investment strategies, but compensation strategies, and in many ways the university is the ultimate hedge fund, as the investors—the students—get none of the returns, while the money managers, who make far, far more than the professors who teach and research, reap the lion's share of the tax, tuition, and federally-funded institution. It has been written that one cannot serve two masters, and that is why the University administrations are the poorest places on earth-you can see it in their eyes, and faces: aging, soulless men who have presided over an era of decline and debauchery, of abortion and illegal immigration, sending forth the young to die on foreign shores in foreign wars, while quietly redefining the study of economics not as something based in a philosophy of moral sentiments, as Adam Smith did, nor based in the truth as Hayek and Von Mises did, but redefining economics as that which transfers wealth from the worker and creator to the bureaucrat. It rips their souls right out, but small-souled men figure that they have not all that much to lose; and as risk-assessment is their delight and specialty, as their Vegas persona makes them seem cool, they figure that selling their small souls for summers off and box seats at the basketball games is a good deal. But the only problem is that the soul is immortal, as agreed to by Homer, Dante, Moses, and Jesus; and no government can go on printing money forever.

The present invention shall capitalize on a future era when the children again follow God and the United States Constitution, when the lie of fiat money—which causes decline and debauchery on all levels, penalizing workers, producers, creators, and savers, while rewarding bureaucrats, paper-shufflers, spenders, debt-lovers, and liars—is exposed. Fiat money encourages the growth of the government and the destruction of the family, and Greenspan and Buffett, while presiding over great economic times as defined in dollars counted down from the mint, also presided over the decline and devastation of fatherhood, motherhood, civilization and the family. The present invention, by allowing the talent to protect and profit from their talent, will help with a cultural, and thus economic renaissance. Contrast Jefferson's quote, “The spirit of resistance to government is so valuable on certain occasions, that I wish it to be always kept alive. It will often be exercised when wrong, but better so than not to be exercised at all. I like a little rebellion now and then,” to Clinton's quote, “You can't say you love your country and hate your government.” The present invention counters the opinions of modern experts and lawyers by supporting Jefferson, not Clinton.

John Locke writes about how the government and corporate bureaucracies want to violate Moses's Law and steal your property, “Whenever the Legislators endeavour to take away, and destroy the Property of the People, or to reduce them to Slavery under Arbitrary Power, they put themselves into a state of War with the People, who are thereupon absolved from any farther Obedience . . . [Power then] devolves to the People, who have a Right to resume their original Liberty, and, by the Establishment of a new Legislative (such as they shall think fit) provide for their own Safety and Security, which is the end for which they are in Society.” The present invention side with John Locke over the snarky lawyers pumped out of law schools as fast as the Federal Reserve, which by the way is violating the Constitution by coining money, pumps out dollars.

The present invention shall help counter big-government-money-printing bureaucrats who enjoy hiring feminists as feminists replace truth and epic story with dull verbiage, and a longing for the material entities over the abstract. Both C. S. Lewis and Samuel Adams agree, “How strangely will the Tools of a Tyrant pervert the plain Meaning of Words!” And C. S. Lewis writes on the erosion of the metaphysical energy amongst students, “The Emancipation of Women. (I am not of course saying that this is a bad thing in itself; I am only considering one effect it has had in fact.) One of the determining factors in social life is that in general (there are numerous individual exceptions) men like men better than women like women. Hence, the freer women become, the fewer exclusively male assemblies there are. Most men, if free, retire frequently into the society of their own sex: women, if free, do this less often. In modern social life the sexes are more continuously mixed than they were in earlier periods. This probably has many good results: but it has one bad result. Among young people, obviously, it reduces the amount of serious argument about the ideas. When a young male bird is in the presence of the young female it must (Nature insists) display its plumage. Any mixed society thus becomes the scene of wit, banter, persiflage, anecdote—of everything in the world rather than prolonged and rigorous discussion on ultimate issues, or of those serious masculine friendships in which such discussion arises. Hence, in our student population, a lowering of the metaphysical energy. The only serious questions now discussed are those which seem to have a “practical” importance (i.e. the psychological and sociological problems), for these satisfy the intense practicality and concreteness of the female. That is, no doubt, her glory and her proper contribution to the common wisdom of the race. But the proper glory of the masculine mind, its disinterested concern with truth for truth's own sake, with the cosmic and the metaphysical, is being impaired. Thus again, as the previous change cuts us off from the past, this cuts us off from the eternal. We are being further isolated; forced down to the immediate and the quotidian.”—C. S. Lewis, Present Concerns: Essays by C. S. Lewis, “Modern Man and His Categories of Thought” (1946), para. 5, pp. 62-63”

So it is that truth for truth's sake is tossed out the window, and women strive to gain command over us physics Ph.D.'s, innovators, and inventors with two year MBAs and law degrees, all based upon the mechanism of wealth transfer from the worker and creator and epic storyteller to the characterless bureaucrat and soulless number cruncher. So the letter of the law, removed from the proper classical context of epic story, triumphs over the spirit of the law, in this fallen, perverted world. The present invention will allow lone artists and innovators to take a stand against the billionaire/millionaire Jobs and Lessigs, the billionaire/millionaire record labels and producers, to protect and profit from their talent. As Churchill states, “You see these dictators on their pedestals, surrounded by the bayonets of their soldiers and the truncheons of their police. Yet in their hearts there is unspoken—unspeakable!—fear. They are afraid of words and thoughts! Words spoken abroad, thoughts stirring at home, all the more powerful because they are forbidden. These terrify them. A little mouse—a little tiny mouse!—of thought appears in the room, and even the mightiest potentates are thrown into panic.”

The more they deconstruct the eternal mythologies, the more they destroy both men and women and manhood and womanhood and childhood, the more they will reign supreme like Sauron, Darth Vader, The Matrix, and Voldemorte, all rolled into one. The present invention allows the talent who lives on the shire—the honest creators and artists—to protect and profit from their creations.

Hayek, the Nobel Laureate economist who has been banned from the academy of those who pen the propaganda for the money-printers, would support the present invention, “Even more significant of the inherent weakness of the collectivist theories is the extraordinary paradox that from the assertion that society is in some sense more than merely the aggregate of all individuals their adherents regularly pass by a sort of intellectual somersault to the thesis that in order that the coherence of this larger entity be safeguarded it must be subjected to conscious control, that is, to the control of what in the last resort must be an individual mind. It thus comes about that in practice it is regularly the theoretical collectivist who extols individual reason and demands that all forces of society be made subject to the direction of a single mastermind, while it is the individualist who recognizes the limitations of the powers of individual reason and consequently advocates freedom as a means for the fullest development of the powers of the interindividual process.”

The spirit of the present invention is non-obvious as it counters the spirit of our contemporary experts. In the original Beowulf, our Hero Beowulf killed Grendl's mother. In the new Beowulf, our confused Hero Beowulf slept with her. In the original 3:10 to Yuma, the good guy lived and the bad guy went to prison, but in the latest remake, the good guy dies as the bad guy gets away free, as Hollywood producers get away with murder in creating art in their own image. So too have technologists created art in their own soulless image, stripping it of Moses's ten commandments and the United States Constitution which salutes the Natural Rights of the artist and author to protect and profit and own their content. In his 1906 address to congress, Mark Twain saluted both the Constitution and that earlier Decalogue which stipulated that one should not take another's profit—that one should not steal. The present invention sides with Twain, the Founding Fathers, Moses, The Constitution, and the Bible, in proposing a novel method, system, and talent agency for protecting and profiting from one's content.

Karl Marx, who opposed property rights and God and religion and who is the patron saint of the majority of academics, wrote, “1. Abolition of property in land and application of all rents of land to public purposes. 2. A heavy progressive or graduated income tax. 3. Abolition of all rights of inheritance. 4. Confiscation of the property of all emigrants and rebels. 5. Centralization of credit in the banks of the state, by means of a national bank with state capital and an exclusive monopoly. 6. Centralization of the means of communication and transport in the hands of the state. 7. Extension of factories and instruments of production owned by the state; the bringing into cultivation of waste lands, and the improvement of the soil generally in accordance with a common plan. 8. Equal obligation of all to work. Establishment of industrial armies, especially for agriculture. 9. Combination of agriculture with manufacturing industries; gradual abolition of all the distinction between town and country by a more equable distribution of the populace over the country. 10. Free education for all children in public schools. Abolition of children's factory labor in its present form. Combination of education with industrial production, etc.” So it is that by centralizing the banks, letting the Fed print money, and demolishing property rights and DRM, Karl Marx takes us one step closer to tyranny. But the wise Founding Fathers, Nobel Laureate economists, and history all counter Karl Marx and the prevailing and dominant opinions of the postmodern professors: “The system of private property is the most important guaranty of freedom, not only for those who own property, but scarcely less for those who do not.”—Fredrich August von Hayek, Nobel Laureate in Economics. “The moment the idea is admitted into society that property is not as sacred as the law of God, and that there is not a force of law and public justice to protect it, anarchy and tyranny commence.”—John Adams

Of course Apple ultimately opposes DRM, as DRM profits artists, not Apple. The labels have been destroyed both by their postmodern ideology which removed epic story form the center and circumference of their music, for without God, there can be no love, and without love, there can be no love songs. As the family and trust are destroyed, so too are the need for loves songs, but only in the short term, for along with new DRM systems and new innovations such as that disclosed in the present invention, a brand new generation of artists shall. As Jobs, the freetards, and the transferres of wealth form the creatores to the Wall Street bankers et al profit off the decline and destruction of the artistic and cultural industry as outlined in The Cult of the Amateur: How Today's Internet is Killing our Culture by Andrew Keen, as well as back-dating options; as the Fed prints money to grow the government and destroy the family; new artists, just now being born, shall throw off the postmodern shackles and exalt a renaissance in music, in movies, and in digital rights management. For the right of an artist to protect and profit from their content is a sacred right, given by God's Natural Law, recognized by the United States Constitution.

The present invention goes against the opinion of the experts, in that it recognizes that the technology exists for artists and authors to protect and profit from their work. This novel talent agency will allow artists and authors to profit in manners not hitherto known nor embodied on the present web. Here are some more Words which support the The Entrepreneurial Premise at the center and circumference of the present invention, and which snarky academics scoff at, but will never destroy nor kill:

“The classic system—owner's capitalism, had been based on a dedication to serving the interests of the corporation's owners in maximizing return on their capital investment. But a new system developed—manager's capitalism—in which, Pfaff wrote, “The corporation came to be run to profit its managers, in complicity if not conspiracy with accountants and managers of other corporations.”—John C. Bogle, Founder and Former Chairman of The Vanguard Group, The Battle for The Soul of Capitalism

“There's a difference between us. You think the people of this land exist to provide you with position. I think your position exists to provide those people with freedom. And I go to make sure that they have it.”—William Wallace in Braveheart, by Randall Wallace

“Man should not be in the service of society, society should be in the service of man. When man is in the service of society, you have a monster state, and that's what is threatening the world at this minute.”—Joseph Campbell, author of Hero With a Thousand Faces

The present invention allows the artist and creator and talent to serve the people. Instead of allowing the technocrats and bureaucrats who have ever pillaged the artists while plundering the people. The present invention supports the spirit of Albert Einstein, going against the snarky spirit of the string theorists. Einstein wrote, “The highest principles for our aspirations and judgments are given to us in the Jewish-Christian religious tradition. It is a very high goal which, with our weak powers, we can reach only very inadequately, but which gives a sure foundation to our aspirations and valuations. If one were to take that goal out of its religious form and look merely at its purely human side, one might state it perhaps thus: free and responsible development of the individual, so that he may place his powers freely and gladly in the service of all mankind. There is no room in this for the divinization of a nation, of a class, let alone of an individual. Are we not all children of one father, as it is said in religious language? Indeed, even the divinization of humanity, as an abstract totality, would not be in the spirit of that ideal. It is only to the individual that a soul is given. And the high destiny of the individual is to serve rather than to rule, or to impose himself in any other way.”—Albert Einstein, Einstein's Ideas and Opinions, pp. 41-49.

Just recently it was reported that The Warner music group is now selling DRM-free music on amazon.com. Well, this has nothing to do with being against DRM, nor does it have anything to do with being from DRM, nor does it have anything to Warner enjoying music. A slashdot.org reader points out, “This isn't about record companies deciding DRM is bad. It is about making sure Apple doesn't control the distribution of digital media.”—http://slashdot.org/article.pl?sid=07/12/27/2327239&threshold=−1

DRM is not bad. Ripping off artists and consumers is bad. Free markets are not bad. Free markets controlled by monopolies or cartels are bad. Money is not bad. Printing money and lying and hyping to rip people off is bad. Wealth is not bad. Theft is bad. And when the artists and talent are commonly afforded a full-spectrum of DRM tools, truth, justice, and art will prevail.

### FURTHER BACKGROUND OF THE INVENTION/PRIOR ART

Online talent agencies abound for models, photographers, actors, actresses, and other talent. The talent does not get paid from the talent agencies, even though the talent provides the content via which the talent agencies often generate revenue and profits via online ads. Sometimes the online talent agencies even go so far as to charge the talent.

Prior and current art include:

Lacasting.com
ModelMayhem.com
Talent6.com
Newfaces.com
Talentnetworks.com
Nowcasting.com
Actorsaccess.com
Talenthunter.com
1modelplace.com
Elance.com
Deviantart.com
Pbase.com
Entertainmentholdingsinc.com

The above prior art represents talent databases that allow talent to create profiles and upload content including headshots, photography, reels, pictures, writings, video, art, photos, bios, and more. The above prior art allows those seeking talent to browse listings and profiles, search on keywords, and upload casting calls. However, the above prior art does not allow the talent to watermark their digital content nor protect their digital content, be it pictures, photos or other digital content. Nor do the above talent agencies allow those who create profiles to sell and advertise products, either products and merchandise created by the talent, or products and merchandise sold primarily by the agency. The above prior art allows the listing of casting calls for talent, the listing of talent profiles, and the searching of both talent databases and casting call databases, but it does not allow the talent the opportunity to protect and profit from their content. Nor is the talent allowed to participate in revenue generated by advertising sold on the sites belonging to the prior art.

Unlike the present invention, there exists no talent agency that provides the talent with DRM tools.

Unlike the present invention, there exists no talent agency that provides the talent with watermarking tools.

Unlike the present invention, there exists no talent agency that provides the talent with opportunities to sell merchandise.

Unlike the present invention, there exists no talent agency that provides the talent with opportunities to sell their own merchandise.

Unlike the present invention, there exists no talent agency that provides the talent with opportunities to sell ads.

Unlike the present invention, there exists no talent agency that provides the talent with opportunities to share profits from the selling of ads.

Unlike the present invention, there exists no talent agency that provides the talent with opportunities to share profits from the selling of merchandise.

Unlike the present invention, there exists no talent agency that provides the talent with opportunities to share profits from the selling of merchandise and/or the selling of ads, based on a tiered revenue-sharing formula, where the better talent receives more revenue.

Unlike the present invention, there exists no talent agency that provides the talent with the novel banner-rotating system described herein, which naturally maps profits to profiles of the talent, based upon the nature of the underlying social network.

The present invention, the 45 Talent Agency, will allow the talent to protect and profit from their content. In addition to creating profiles and searching casting calls, the talent will also be able to protect and profit form their content. They will be able to tag their content in such a manner that they are afforded the opportunity to receive a cut of the advertising sold about their content. The ads served will make note of the tags in the content, being sure to compensate all the owners.

### Multi-Talent Tagging for Compensation Method

Consider a video that appears on youtube. The video clip will generally have a combination of a cameraman, actors, writers, participants, musicians, directors, and other owners of intellectual and digital properties. The present invention will afford a tagging system that would be capable of compensating all the talent in a method defined proportionally to what the talent chooses. For instance, the talent may come up with the following scheme for sharing revenues, based on the contribution of the various talent:

| | |
|---|---|
| Writers | 20% |
| Director/Cameraman | 20% |
| Musicians | 20% |
| Actor #1 | 10% |
| Actress #1 | 30% |

Thus, every time the clip is viewed, the resulting revenues from sales or advertising are split amongst the various talent. The media has been tagged with the percentages. The options of breakdown proportions are infinite, and could be set to anything agreed upon by the participants. For example, the compensation sharing scheme could encourage the creators of the media to tag it as follows:

| | |
|---|---|
| Writers | 30% |
| Director/Cameraman | 10% |
| Musicians | 10% |
| Actor #1 | 20% |
| Actress #1 | 30% |

And so the compensation would be shared by all the participants.

A further embodiment of this present invention would be where all participants in any video receive a flat rate, meaning that if there are five participants, each one gets a fifth of the revenue, for simplicity's sake.

A universal tagging system, transcending all applications and delivering revenue to the talent independent of the platform or operating system or hardware the content is viewed on, could be conceived. Thus talent would be forever compensated wherever their content is played.

A large problem of the new technology is that it is all a product of old media companies and postmodern business and law schools, where it is automatically assumed that the individual has no or limited rights, and that only the aggregating bureaucrats can or should receive any compensation.

Just as they have destroyed the epic story underlying the United States Constitution, thusly removing it from the context wherein it could make any sense, so too have they destroyed the epic story underlying film, movies, and video games. They have placed the bottom line over the higher ideals, and thus they leave the greater wealth—billions of dollars—on the table.

But new technological systems shall arise that allow the creators to protect and profit from their content. New technological systems shall afford databases of talent that allow the talent to protect and profit from their content. The rising generation shall create both tomorrow's epic art and tomorrow's epic technology, which will allow the rising generation to protect and profit form their content.

The present invention pertains to a talent agency that allows the talent to profit in multiple, novel manners. While online and offline talent agencies abound, as well as social networks and talent databases and talent communities, none of them allow the talent to profit via defining the rights to their content, including videos, pictures, photography, headshots, music, and more. Nor do the talent agencies allow the talent to profit from selling merchandise including clothing pictures and calendars, or being compensated for merchandise sold from the talent agency's site, or being compensated for driving traffic and enhancing merchandise sales and ad sales at the agency. None of the talent agencies provide the talent with The 45 Revolver nor direct access to a suite of rights-protection and DRM tools.

The present invention pertains to a talent agency that allows the talent to make money in several methods, including a simple, tiered banner-rotation system in an online community or social network, which cycles through different user's adcodes in serving banners, so as to serve banners in various places on the pages, which compensate various users, based upon the path that is being traversed in the social network.

After the boomers have destroyed the music industry, Hollywood, New York Publishing, marriage, and the US Constitution, a new generation shall rise to bring forth an artistic and cultural renaissance. All the boomer's actions are motivated by transferring wealth from workers and creators to the elite lawyers and MBAs who oft take out massive loans to join the elite club of snarky, postmodern hipsters. The great thing about the system is that the boomer elite print the money that is leant to the future soulless MBAs and lawyers, and the debt they enter into serves as insurance that they will never question the soulless groupthink. The boomers have removed Homer, Dante, Shakespeare, and the Bible from the University, as in the Bible Moses said “thou shalt not steal,” and thus Moses gets in the way of the boomer money-printing machine; as does Odysseus, who states, “go forth and tell them that fair dealing leads to greater profit in the end.” They print dollars, make loans to MBAs and lawyers, and then send them forth to come up with schemes to attack digital rights management and transfer all the wealth from the writers, artists, and creators to Wall Street bankers. One of the funniest things are all the soulless bureaucrats at universities who consider themselves entrepreneurs and creators of wealth, while in reality all they have ever done is fought to get as close to the money-pump as possible, creating bureaucracies that are the very opposite of entrepreneurs, which inevitably seek to criminalize the creator. They are often economists or some other form of pseudo-scientist who plays with fake numbers and use mathematics to obfuscate and obscure the individual's Character and Natural Rights, en route to transferring all the wealth to their little entourage, and all the risk to the honest worker and investor. They confused printing dollars with actually creating wealth, and that is why Dante placed them in hell along with all those who committed crimes against nature, for although both are printed on paper, there is a difference between penning epic literature and printing money; just as there is a difference between telling the truth and lying. And Dante considered usury a crime against nature and the arts; as while the artist and talent actually create value, the usurer merely prints money. Of course finance and bureaucracy are necessary to the growth of the economy, and so are empires, wars, obfuscating, and theft.

Digital content is immortal, and the present invention will afford a talent agency that will allow the talent to define and declare rights to their content and talent, and begin profiting it as they protect it. The costs of production and global distribution have plummeted, and the guilds mean less and less—indeed, they can often now stand in the way of an artist protecting and profiting form their own work.

Itunes was not created for the artists nor consumers. It was created for the record labels and Apple—it was created for Wall Street. And thus it cuts the artists out of the profits for the most part, and too, Steven Jobs wants to eliminate DRM for artists, as he just wants to sell the devices. The technology of the internet provides a system to eliminate the middleman, to allow the artists to define rights to their work and sell it directly to consumers, thusly providing customers maximum value and artists maximum compensation. Billions of dollars are invested into law schools and MBA and journalism programs to intimidate and scorn the indie artist and those who would provide them the tools to protect and profit from their content.

### FURTHER OBJECTS AND ADVANTAGES OF THE INVENTION

All their overtures to DRM are just lies, as lying is how the soulless, cynical technologists seek to profit—The Register reported that Steven Jobs was just kidding: “By promising to play nice, and building DRM and TCPA technologies, the computer industry is simply making come-hither noises that the rights holders want to hear. ‘When I was 14, I told girls I loved them to sleep with them too. It was a fiction. Steve Jobs just leaves a little money on the table,” he says. “These theoretical notions of control run headlong into the real historical experience.”—http://www.theregister.co.uk/2004/02/11/why_wireless_will_end_piracy/

And indeed, Steven Jobs has since come out against DRM.

The chief goal of the smirking, soulless boomers and feminist lawyers is to kill religion, destroy the constitution, ban individual rights, and criminalize the talent and creators, separating the creator from their content and the father from his child when they fail in separating the mother from her unborn child. For all these things profit either the government or a wall street bank, which are really one and the same, as the Wall Street banks—the Federal Reserve—print the money used by the government. I'm not sure exactly how it works, but either the Wall Street banks create money out of thin air and loan it to the government at interest, who then loan it back to the banks at higher interest, who then loan it to the people at even higher interest, with little, snarky clauses that raise the interest over time, whereupon the people can't pay anymore, and then the Wall Street banks come to own their homes. So it is that that which is created out of thin air can be converted into physical property, as well as pain, suffering and woe of the man who loses his home. Or maybe the government creates money out of thin air and loans it to the government at interest, who then loans it back to the government at an even higher rate, who writes checks to academics and feminists and string theorists and economists to publish and promote complete gibberish or mindless entertainment such as The World is Flat or Freakanomics, as the family is destroyed, the country is placed in massive debt, and young soldiers are sent to die in foreign wars on foreign shores.

The present invention allows artists and talent to circumvent the snarky machinations of the soulless lawyers and characterless MBAs being pumped out of federally-funded institutions almost as fast as the fed pumps cash on out. The pomo-hipster lawyers and MBAs have destroyed art, music, and film by placing mammon over God, and the present invention will allow the talent to place God over Mammon by laying claim to their fundamental, divine right to protect and profit from that which they create. By providing the talent with DRM tools, the talent is allowed to sell directly to consumers and fans; and too, the talent is allowed to protect and profit from their talent, as they also enjoy all the other perks of a talent agency, such as the booking of gigs, contract negotiations, and the scouting of opportunities and parts.

The present invention may also allow lawyers and legal representatives, as well as other experts, to list and sell their services. The present invention may also provide sample legal forms including release forms, employment forms, work-for-hire forms, and others.

Imagine a web 2.0 company that offers a simple means and method by which users might profit, and by which users may be inspired to build bigger, higher-quality networks. Such an invention would be the killer-app of web 4.0/5.0.

Imagine a talent agency that pays the talent in a social network, based upon a simple, tiered banner-rotation system, which cycles through different user's adcodes in serving banners, so as to serve banners in various places on the pages, which compensate various users, based upon the path that is being traversed in the social network.

Imagine an online talent agency that pays the talent advertising revenues, and allows that talent to invite and attract more talent. The talent would be inspired to invite other talent and build the quality of their network, as they would be paid more.

Imagine an online talent agency that allowed the talent to participate in the sale and marketing of merchandise, clothes and clothing; being compensated for the sales of clothes and clothing.

Imagine an online talent agency that allowed the talent to tag content with rights definitions so that they were duly compensated whenever and wherever their content was viewed or played.

Imagine a new device—the 45pod—which allowed the use and playing of multiple DRM formats and audio and video formats, and which could purchase and download songs directly from the artists, creators, or musicians websites.

The present invention could be built by anyone skilled in the art of building and creating database-driven websites, who also possessed knowledge of commerce, DRM, and ecommerce. The present invention could be implemented and maintained by a small team skilled in the art of ecommerce, webhosting, and web-design.

### FURTHER OBJECTS AND ADVANTAGES OF INVENTION

Many online talent agencies are databases or social networks which allow the browsing and surfing of profiles, photography, videography, and other content created by numerous and varied creators. Many of the talent agencies serve banner ads or text ads within the profiles, thusly profiting from the content. But the creators are never compensated, nor given an opportunity to profit from serving ads.

Talent agencies/social networks such as modelmayhem.com place google ads alongside the model's pictures, but they don't allow models to place ads beside their pictures.

Nowcasting.com does not provide an opportunity for photographers, actors, and others to post ads alongside their headshots photography, nor profit from advertising displayed along with their work.

Artists, authors, models, videographers, photographers, and other musicians and creators are leaving billions of dollars on the table. Artists, authors, models, and creators are providing all the content for the numerous Web 2.0 companies, but rarely profiting in it, nor sharing in the profits. When youtube sold for $1.6 billion to google.com, the vast majority of the legal filmmakers and videographers were not paid a penny. Those who uploaded all the illegal content weren't paid either, but Google paid millions to traditional media companies to ward off lawsuits. How much of that went to the actual creators, if any of it, is not known.

The creator is treated as a commodity by the plethora of Web 2.0 companies, whose value lies in the mass aggregation of creators, who are generally told that they have no value on their own. The lone creator is told that they no rights to protect nor profit from their content, but that their only option is to share it, as serf's in Larry Lessig's corporate fiefdom, manifested by Google, Yahoo, and the plethora of Web 2.0 companies.

This is the era of the “long end of the tail,” wherein hits supposedly no longer matter. This is the era of the wisdom of crouds—crouds elected Hitler and voted to crucify Jesus, while the Individual Artist gave us Beethoven's nine symphonies, Shakespeare's tragedies and comedies, and Homer's Odyssey, as well as Newton's law of Gravitation and Einstein's improvement upon it. “When everyone is an artist,” the postmodern money-printing boomers declare from the pinnacles of the dot com hoaxes, “then nobody will be an artist.” So it is that the dismissal of property rights one and the same thing as the dismissal of classic, epic storytelling. So it is that myspace bands will never be afforded the same prestige nor respect as Johnny Cash, Janice Joplin, and Bob Dylan, for the primary business method is now amassing millions of crass, illiterate teenagers, rather than supporting, creating, protecting, and profiting from immortal art.

The present invention, by empowering and enriching the talent—the creator—will foster a cultural renaissance. The profitable Flickr profits off the creations and participations of photographers and models—indeed, it charges money for a professional account, and now and then serves as alongside the photograph, but the actual creator is banned from serving an ad alongside their photograph. While Lessig et al are given millions to destroy the indie artist's property rights so that massive corporations might profit, here are what artists, and those who support artists, like Eminem:

The Register reports:

http://www.theregister.co.uk/2007/07/31/eminem_sues_apple_again/ “Eminem's music publisher has filed a multimillion-dollar lawsuit against Apple over iTunes downloads, alleging the company is violating copyrights by selling the rapper's song online. The lawsuit was filed Monday in US District Court in Detroit by Ferndale-based Eight Mile Style and Eminem's copyright manager, Martin Affiliated. The complaint alleges that although Apple has inked a contract with Universal Music Group to sell Eminem's music on iTunes, Eight Mile Style and Martin Affiliated have not authorized the downloads . . . “Eight Mile and Martin have demanded that Apple cease and desist its reproduction and distribution and Apple has refused,” the complaint states . . . The lawsuit is the second time Eight Mile Style has taken Apple to court. In 2004, the rapper sued Apple over using the song “Lose Yourself” in a TV spot for the iTunes music store. The lawsuit claimed Apple's agents tried to seek permission for the song, but had been rebuffed. The lawsuit was settled out of court in 2005.”—http://www.theregister.co.uk/2007/07/31/eminem_sues_apple_again/

Other artists speak out here:

http://www.riaa.com/newsitem.php?news_year_filter=&resultpage=104&id=C2DF1B61-1F41-7B73-D68F-EB3AAECF6BCA

“I am excited about the opportunities presented by the Internet because it allows artists to communicate directly with fans. But the bottom line must always be respect and compensation for creative work. I am against Internet piracy and it is wrong for companies like Napster and others to promote stealing from artists on-line.”—Elton John

“Artists, like anyone else, should be paid for their work.”—Lou Reed

“Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.”—Lars Ulrich, Metallica

“As an artist and songwriter I believe that this is an issue that needs to be looked at and taken very seriously. In what other industry can someone take a product, not created by themselves, make money from the use of that product and not compensate the original creator? Someone needs to take a stand and protect the songwriters and artist.”—Victoria Shaw, country music singer/songwriter

“I think the fact that Napster is stealing recorded music is something that we have to stop. It's taking money out of my kid's mouth. That's the way I look at it. It's wrong. It's inherently wrong. It's stealing.”—Art Alexakis, Everclear

“Many artists have spent their lives honing their craft and now some anonymous person in a little dark room with a computer somewhere is able to collate that lifetime's work and pass it around the world for free. It's just not on. Stealing is stealing regardless of what name you choose to call it. You get people saying ‘I've been a fan of yours for twenty years, I'm entitled to have it for free’. Well I'm afraid you're not. That's no different to me than going down to the local greengrocers and saying ‘well, I've been coming here for twenty years and so I'm going to help myself to all your fruit and vegetables from now on thanks very much.”—Matt Johson of The The

“As a band, we are incensed at the amount of disregard Napster has toward how musicians make a living. We only get paid from our recordings if they are bought in legal ways. By disregarding copyright laws we lose out. We are a ‘baby band’, struggling to stay alive financially. Every dollar we lose to “fans” stealing our music hurts . . . if folks knew that the majority of the major label bands are not making any income from their recordings . . . and losing money by touring, they would be astounded and a bit more sympathetic to the artists. What is supposed to set the industry free is killing it.”—The Push Stars

“There are laws against piracy in this country, and unless we enforce them, how do we expect any other country to care about protecting our rights from piracy?”—Denyce Graves, RCA Victor Red Seal, Classical recording artist

“Everyone I know is excited about all the possibilities the Internet has to offer. As a musician, the Internet has made it possible for me to share my music with people that could have never been reached by conventional methods. It has been taboo for artists to speak out concerning the business side of their music. The fear has been that the buying public, as well as other artists, would perceive this concern as greed, and that the artists' sole purpose for creating was the money. This perception has silenced many artists concerning MP3 and Napster. The silence must end. As a child I created music to express my inner thoughts and feelings, and that purity has stayed with me throughout. The day I decided to share my music with the world, was the day I decided to walk the fine line between art and commerce. I have been blessed in that I do what I love and can support my family with what I create. When my music is given away, as taboo as it is for me to say, it is stealing. I need not defend my motives for making music, but the distribution of my music has made me business conscious. I have decided to sell my music to anyone who wants it, that is how I feed my family, just like a doctor, lawyer, judge, or teacher. Not to insult anyone's intelligence, but my music is like my home. Napster is sneaking in the back door and robbing me blind.”—Scott Stapp, lead singer/lyricist for Creed

“It's high-tech bootlegging, with artists definitely losing revenue. I appreciate that people like my music enough to download it. But we need to join forces and fight this.”—D J Scratch, artist/producer Billboard, Apr. 15, 2000

“[Napster] is particularly discouraging to young artists and songwriters trying to get their foot in the proverbial door of the music business. I suppose it should be a compliment that people dig your music so much that they're swapping it online. But thievery is thievery. If you dig an artist that much, then you should want to help keep that artist alive by purchasing the actual recording.”—Anastacia, Daylight/Epic recording artist Billboard, Apr. 15, 2000

“If artists don't get paid for making music, how are they supposed to survive? Stealing from an artist is not the best way to show your appreciation for their work.”—Aimee Mann Entertainment Weekly, Mar. 31, 2000

“Artists should be compensated for the work that they do.”—Deborah Harry of Blondie Salon, Mar. 25, 2000

“No matter what you do for a living you should get paid for your work, whether you're washing dishes or recording songs.”—Bif Naked Salon, Mar. 25, 2000

“Nobody wants to look the artist in the eye and say, ‘Giving your music away for free is going to make you lots of money’—not while keeping a straight face, anyway.”—Kristin Hersh, Throwing Muses Salon, Mar. 25, 2000

“Artists should be compensated for their work and protected against a technology that allows copyrighted music to be illegally downloaded. But Napster and technologies like it are just a part of the overall problem. Intellectual property in the Internet Age must be staunchly protected. Without meaningful safeguards, the livelihood of the creative community is at risk.”—Mike Greene, President and CEO of the National Academy of Recording Arts and Sciences

“. . . We send them [artists] to Napster and they see all their work being given away for free, and they're stunned and horrified. What disturbs me the most is that artists are never discussed. Artists just seem to be a ping-pong ball whacked back and forth and nobody gives a fuck about them . . . And it turns out Napster's no better than the record companies. In fact, they're worse, because they're offering nothing and taking everything. Napster's the tip of the iceberg. The broader question is intellectual property on the Internet. Intellectual property should be valued and protected or we'll go down. And not just music either. Why would anybody sit down and write a novel it it's going to be pirated for free the first day it's released. If nobody values intellectual property, then we'll all be in the insurance business.”—Ron Stone, Gold Mountain Management (represents Bonnie Raitt, Tracy Chapman, Ziggy Marley and others) Salon, Mar. 25, 2000

“The artists, writers, and labels aren't being compensated. It's certainly not the way copyright laws were set out to work . . . when managers and artists and labels have no control and it's a free-for-all out there, it's problematic.”—Mike Robertson, Mike Robertson Management (represents Nitty Gritty Dirt band, Wade Hayes, BlackHawk and others) Billboard, Apr. 15, 2000

“All of a sudden a song could get out without the act's knowledge or the label's knowledge, and all the hard work that's been put into the project is then lost.”—Ken Crear, Creative Management Group (represents Next, Sisqo, Mary Mary and others) Billboard, Apr. 15, 2000

“Napster is robbing me blind.”—Chris Robinson, Black Crowes Salon, Mar. 25, 2000

“It pisses me off and I resent it. I spent $15,000 on my Web site. I paid a publicist for a year and a half out of my own pocket. And now some kid's going to tell me my catalog should be free? They're just entrepreneurs setting themselves up to make a ton of money off other people's work. Where's the compensation for the artists? I know people using Napster are chuckling about kicking big, bad record labels. But as evil as the record companies may be, at least they're paying for your recording budget, and at least they're promoting you, and paying for tour support. We can make a new model—yeah right. It's laughable. Those people have no idea how the music business works. Because unless you're Alanis Morissette or Dave Mathews, you're not making money on the road. It's all I can do to break even on tour. And the only reason to tour is to promote the sale of my CD.”—Jonatha Brook Salon, Mar. 25, 2000

“Our label is behind us from the start. They work hard for every nickel they make off us. They deserve to be paid. It's a no brainer. If it's not scanned, then the label at the end of the year says so long, and all of a sudden our careers are over, and I'm back at McDonald's. —Morgan Rose, Sevendust Salon, Mar. 25, 2000

“If Napster had out best interest in mind then they would ask our artists. Nobody at Napster has ever called to ask our permission. Artists say ‘Ask me.’ Explain what it is and ask if I want to participate. But Napster doesn't give them an opportunity. They're basically saying fuck the workers. Let them work their asses off and we'll give it away for nothing. The bigger the lie the more you get away with, I suppose. There's no question Napster's going to lose in court. The only question is how much money in damages they'll have to pay. I hope it's enormous because then the big money investors, which Napster needs, will walk away.”—Cliff Burnstein, Q Prime Management (represents Red Hot Chili Peppers and Metallica) Salon, Mar. 25, 2000

“Investors are going to realize it's a theft business and ask, how does it make money? It doesn't. It's all very well to say music should be free, but the reality is if you don't pay the artists, the road crew, the musicians, the recording studio, if there's no money in music, there's not going to be much music left. How many people would be doctors is they had to work for free? What if we said, ‘Hey, the airlines are ripping us off and we don't want to pay for tickets, we'll just steal them.’ Guess how long the airlines would last? If it becomes free, then it becomes extinct.”—Miles Copeland (manager for Sting) Salon, Mar. 25, 2000

“I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”—Sean “Puffy” Combs, CEO, Bad Boy Entertainment, Inc.

“Dixie Chicks and Senior Management are huge fans of the Internet and its possibilities. While there are great efforts being made to ensure that the rights of the artists and songwriters are protected, Napster's apparent way of doing business sets those efforts way back. If the Internet thieves are not stopped or better regulated, it not only robs current artists but might have even more serious repercussions for the next batch of artists. I support and applaud the RIAA on their efforts to make sure that Internet companies are not stealing the rights of the people who make the music.”—Simon Renshaw, Senior Management (personal manager of the Dixie Chicks)

“The band's music comes from the heart, and knowing how much hard work goes into making that music, this type of Web site makes us sick.”—Rusty Harmon, Fishco Management (represents Hootie & The Blowfish)

“Copying and distributing music illegally is the ultimate discrimination. It sends a message to our neighbors who create musical art that what they do, who they are, is not important enough. Does it matter? I can think of several stories where the rights of a particular group of people were deemed unimportant. None of them have a happy ending. Therefore, I strongly urge the operators of NAPSTER to use their technological acumen to bring an end to the trafficking of pirated musical works.”—Frank Breeden, President, Gospel Music Association, Inc.

“With the increasing accessibility of on the Internet, and the new technology available on it, there must be a matching increase in responsibility. Without public accountability, this responsibility reverts to groups like the RIAA to seek out those who are misusing the advances in technology and to the courts to adapt and enforce the law. Napster is allowing people to disregard copyright laws because they were not written in the spirit of today's technology. These copyright laws are the only things that protect what musicians do for a living; write songs. Napster is allowing people to steal these songs.”—Jeff Cameron, Jeff Hanson Management & Promotions (represents Creed and other artists)

“Napster is undermining the efforts of creators and innovators of all kinds who are at the forefront of the electronic marketplace.”—Robert Holleyman, President and CEO, Business Software Alliance

Although the free, original Napster is gone, so now does DRM seem on its way out, which means that it will be pretty much all original Napster, all the time.

In an amazon review for J. D. Lassica's Darknet: Hollywood's War Against the Digital Generation (Hardcover): http://www.amazon.com/exec/obidos/tg/detail/-/0471683345/ Gives the people what they want to hear at artists' expense, May 28, 2006 Reviewer: Steve Jimenez “Steve Jimenez.” This book makes me very very angry, and not in the way that the author wants. He clearly wants me to be angry at big media for keeping me from doing what I want with my content whenever and wherever I want to. He gives story after well told story of how the law stops people from doing clever and creative things like adding video to their Sunday sermons. But he completely ignores the artist. Without the artist, his big media has nothing to offer. Doing the things he advocates makes it impossible for the digital artist to earn a living in their primary medium. That is why the laws that he so wants to change are there in the first place. He wants you to forget that by telling one side of the story. I, as a digital artist struggling to make a living, cannot forget that side of things.”—from http://www.amazon.com/exec/obidos/tg/detail/-/0471683345/

http://www.amazon.com/gp/product/customer-reviews/0471683345 reports: “This book misses the point, Apr. 1, 2006 Reviewer: Arnaud “Arnaud” (Venice, Calif.)—This book tells us that consumers are hurt by big media. My friends are artists, and I know that they are hurt by the arguments made in this book. The book encourages file sharing, which I have no problem with in general. But the book does not give artists a say in the matter. That really hurts them. I know it is easy to agree with this book. But that doesn't mean it is right. Artists have rights, too. Some choose to work with big media companies. Some choose to be indie. But that should be their choice. Not the Darknet's. http://www.amazon.com/gp/product/customer-reviews/0471683345 stridently anti-artist tome, Mar. 3, 2006”

Reviewer: Dana Cara “Dana Cara” (Atlanta, Ga.)—See all my reviews This book is one of the most one-sided books on this issue that I have read. J. D. Lasica thinks that issues of artist expression and legal protection are only about consumer rights and consumer freedom. J. D. Lasica totally ignores artists' rights and artists' choice. He argues that if you create art you should be denied your (copy)right to decide what happens to it. J. D. Lassica's entire premise is that it is ok to take that (copy)right away from you; either because your work should be in the public domain and not captive to ‘outdated’ concepts like copyright—as in the rights of artists to control copying of their work, or the work is unjustly controlled by those nasty big media companies who deserve to be screwed. Well, if I want to sell my work to a big media company (like you do, J. D.), and you encourage people to take my work for free, then the market value of my work is shot down. The philosophy that this argues for is cruelly unjust. Shame on you, J. D., for writing such an unbalanced book.”—http://www.amazon.com/gp/product/customer-reviews/0471683345

In a review for Lessig's The Future of Ideas: The Fate of the Commons in a Connected World (Hardcover), an amazon customer writes, http://www.amazon.com/Future-Ideas-Commons-Connected-World/dp/0375505784 “From whence comes invention?, Mar. 30, 2004, Reviewer: D. Mitchell—See all my reviews (REAL NAME), “Ultimately, the flaw in Lessig's books is his belief that the revolution of personal computing and the internet are the products of intellectuals like himself. Undermining the freedom and property rights of the programmers and companies who really invented these marvels is a profound threat to one of America's most vital and creative industries.”

Here's another view of Lessig's work from someone concerned for artists and inventors: http://www.amazon.com/gp/product/customer-reviews/0375505784 More Anti-Capitalist Tripe, Jan. 2, 2002, Reviewer: Blake Scholl “upstart” (Seattle, Wash. United States)—See all my reviews, (REAL NAME) Greedy corporations are taking over the world, capitalists steal from the little guy, (intellectual) property rights are coercion, ideas belong to the masses. Sound familiar? It should. We've been hearing the same tired message from Karl Marx's intellectual brethren for over a century. Undeterred by enormous increases in the length and quality of living in nations recognizing (intellectual) property rights, the Lawrence Lessigs of the world are still struggling to wipe-out, roll-back, compromise, or otherwise water-down the right to (intellectual) property. The programmer's right to his code, the musician's right to his melodies, the chemist's right to his formula, and the businessman's right to his trademark are just as absolute—and just as necessary—as the farmer's right to his wheat and the miner's right to his coal. In fact, it is intellectual property rights, which guarantee a man's right to his *intellectual* products, that have allowed men to climb out of mines and support themselves through *intellectual* effort. Contrary to Lessig's premise, strong patent and copyright protection is even *more vital* in the new digital world. As an increasing amount of wealth is intellectual—such as movies, music, software, paintings, drugs, and web sites—the rights of the producers to keep, trade, license, and dispose of their intellectual creations is crucial: Practically, in order to make intellectual effort a means of earning a living. Morally, in recognition of their productive efforts. The irony of Lessig's work is captured in the classic Orwellian phrase, “Some property rights are more equal than other property rights. For more of the same theories you've heard in books, newspapers, and movies for years, read this book. For a fresh explanation of the moral and practical necessity of intellectual property rights, read “Patents & Copyrights” in Ayn Rand's “Capitalism: The Unknown Ideal”—from http://www.amazon.com/review/product/0375505784?filterBy=addTwoStar, By Blake Scholl “upstart” (Seattle, Wash. United States)

For while Google and Apple have vast numbers of patents, trademarks, and copyrights, which Lessig supports, the indie creator in South Dakota or the Tennessee mountains are to be denied their fundamental constitutional rights, so that youtube, Google, and billion dollar corporations can profit off of them, while supporting political candidates who want to further grow the government, print fiat money, and setroy the family, motherhood, fatherhood, and childhood, either before or after birth, as all forms of keeping mothers from mothering are legal, as mothers must now serve the corporate and State bottom lines, instead of the higher ideals in the Bible. Ideas have consequences, and Lessig's well-funded campaign against property rights has had resounding and detrimental effects to the way indie artists (meaning all true artists) are allowed to conceive of making a living.

Ayn Rand wrote, “What the patent and copyright laws acknowledge is the paramount role of mental effort in the production of material values; these laws protect the mind's contribution in its purest form: the origination of an idea. The subject of patents and copyrights is intellectual property. The government does not “grant” a patent or copyright, in the sense of a gift, privilege, or favor; the government merely secures it—i.e., the government certifies the origination of an idea and protects its owner's exclusive right of use and disposal.”

So it is that we find ourselves back at Moses—Thou Shalt Not Steal. Property rights are God-given Rights. In the current state of the art, the value of a talent database or social network, which is proportional to the square of the number of users in the social network, rarely lets the users mine the value in the network they create.

### USEFULNESS OF PRESENT INVENTION

A talent agency, talent database, or social network, which lets the talent participate in advertising revenues, in a manner related to the underlying social network, would empower users and thusly attract higher-quality users, resulting in a superior network.

A social network, which rewards users via advertising fees at set forth in the simple banner-advertising algorithm in this invention, would result in an enhanced social network, as users would be given incentive to grow their networks.

As the hardware and software for social networks becomes commoditized, users of social networks will begin to seek out social networks that allow them to share in the profits. The present invention, by offering a simple advertising banner rotation scheme, that distributes advertising revenues in accordance with a tiered structure based upon the underlying social network, will result in an improved and sought-after social network.

The present invention will foster new revenue streams for creative types and talent. There are hundreds of talent agencies online, but none of them allow the users to share in the revenues and wealth that is a natural byproduct of the social network or database. The advertising banner rotation system described within this present invention would allow for a brand new kind of talent agency, wherein the talent gets paid as they network, build their own networks, and invite friends to the talent agency. The more and better talent a user attracts, the more they will be paid, and the greater the value of the network will become.

The present invention will allow users to create their own sub-talent agencies, and be paid in accordance to their size, traffic, and quality of their network. A situation in which the user is afforded an opportunity to have their user's page associated with their own domain name and/or brand may arise. Thus many, many independent talent agencies—models, photographers, actresses, and musicians—could grow upon one central database.

The present invention will allow users to create their own sub-networks, and be paid in accordance to their size, traffic, and quality of their network. A situation in which the user is afforded an opportunity to have their user's page associated with their own domain name and/or brand may arise. Thus many, many independent social networks—could grow upon one central database.

Tiered systems for booking gigs could also be set up.

### Operation

In one embodiment, the present invention would share revenues as follows: Every user with a presence on the site is associated with an ad code. When a browser comes into a network via a certain node, the user of that node has all three ad spaces associated with the ad code.

When the browser follows a link to a user's friend, which defines a new node, the original node's ad code is displayed in the ad to the side and bottom. When the browser follows a further link to node3, node2's ad code is displayed on the side, and node1's ad code is displayed at the top. So it is that ads might be displayed, and ad revenue might be shared, in a manner according to the underlying social network

### BRIEF DESCRIPTION OF THE DRAWINGS

1. FIG. 1: As shown in FIG. 1, representing one embodiment, the ads are rotated in accordance with the underlying social network so that the original and subsequent users who create the pages/nodes are compensated proportionally to the underlying social network. Imagine an online social network that shares advertising revenue with the users, and allows the users to invite other users, which would augment their own traffic, and thus increase their ad revenue. The users would be inspired to invite other users and build the quality of their network, as they would be paid more. FIG. 1 represents the novel banner-advertising system: Every user with a presence on the site is associated with an ad code. When a browser comes into a network via a certain node, the user of that node has all three ad spaces associated with the ad code—the top or header ad code, the sidebar or skyscraper adcode, and the footer adcode. When the browser follows a link to a user's friend, which defines a new node, the original node's ad code is attached to the the skyscraper ad to the side and the footer ad at the bottom. When the browser follows a further link to node3, node2's ad code is associated with the side skyscraper ad, and node1's ad code is associated with the footer ad, while node3's ad code is associated with the prominent header as. So it is that ads might be displayed, and ad revenue might be shared, in a simple and natural manner according to the structure underlying social network. The ad-rotation system of the present invention would allow a natural means for compensating the talent due to a simple, underlying algorithm; which would foster a novel business model. The nodes, or profiles, which received the most exterior traffic would profit the most as all ads would always be theirs. Also, the nodes which are one link deep in the network would profit well, so that the friends on the most prominent profiles would be justly rewarded for their friendships. And so it goes, as this novel ad-rotation system would ensure revenue share in a simple manner that yet efficiently and effectively is proportional to the inherent structure of the underlying network and the traffic generated, thusly ensuring the greatest rewards for the greatest nodes and thusly reward the greatest talent. Such a system could also be linked to affiliate ad codes and an advertising/sales system for merchandise, wherein the ads would link directly to an ecommerce presence owned and operated by the talent agency, whereupon the talent may be compensated for sales of merchandise they drove, in proportion to the prominence of the ads and the ownership of the ads, be they the top header banner, the side skyscraper banner, or the bottom footer banner. Many other banners and rotation systems for talent databases may be developed in the spirit of the present invention, wherein the banners could be served by and link to external ad systems, internal ad systems, external commerce systems, or internal commerce systems. The spirit of the present invention is to allow artists and talent to protect and profit from their profiles and artistic creations and reels and photography and music inventions and innovations in a maximal manner.

The system in FIG. 1 could be extended beyond the immediate network to encompass the world wide web.

2. FIG. 2

FIG. 2 represents the basics regarding how talent might profit from selling and representing merchandise, as well as advertising that is associated with their profiles or friend's profiles.

3. FIG. 3:

FIG. 3 represents a system for defining and tagging rights of a plurality of talent in a digital piece of art, being it a film, song, picture, video or some other combination, in such a manner that the various talent appearing in the said work of art are compensated fairly and justly in proportion to their contributions to the said work of art, and the revenue generated from ad sales associated with the art, as well as purchases of the art. The compensation is defined by the various individuals, representing the talent, coming up with sharing schemes and percentage breakdowns that revenue generated from the said digital piece of art will be split amongst the talent. The system may become a universal system extending throughout all networks and devices, making sure that the talent is always compensated by ad sales or media sales whenever the media is viewed or purchased anywhere in the universe.

### DETAILED DESCRIPTION OF THE DRAWINGS

FIG. 1:

As shown in FIG. 1, the ads are rotated in accordance with the underlying social network so that the original and subsequent users who create the pages/nodes are compensated proportionally to the underlying social network.

In Step A (102), a web surfer or user/browser (100) happens upon the primary page for TALENT1PROFILE (190). All three ad units, including the top ad (195), the skyscraper ad on the right (111), and the bottom ad (110), are served with the primary page's creator's ad code. Thus the primary user is compensated in all three ad spaces, whether the ads are viewed and/or clicked on. In case (105) the user/browser (100) chooses path (105) and clicks on the ad (195). The owner of Talen1profile is compensated in a manner agreed upon with the internal or external ad network. The ads could be served, for instance, by google's adsense, or Tribal fusion, or burst, or some internal ad server, or an affiliate program, or an internal affiliate program for merchandise, or some other party entirely.

Should the web surfer visit the primary page's blog, or gallery, or any other aspect created by the primary user, they will be shown ads with the primary user's ad code in all three paces 195, 111, 110, which thusly will compensate the primary user, when viewed and/or clicked on.

Should the web surfer surf to one of the primary page's friends' page in step B (115) as shown in path (106), such as Friend1's talent profile (191), they will be shown three ads again (166), (117), (122), but this time, the top ad (116) shall have the ad code of Friend1, represented by Friend1Adcode (116). However, the side (117) and bottom ads (122) will still have the TALENT1 PROFILE's (190) creator's ad code, where the surfer/user/browser (100) originally entered the talent database.

So it is that the primary page's (190) owner and their friend (191) are naturally compensated by a sharing of adspace reflecting the underlying intrinsic structure of social network—the inherent information contained in the social network.

The original user (100) may elect (112) to click on ad (117) which contains telnt1's adcode, and thus the owner of Talent1 Profile (190) would be compensated. Revenue may be shared with the owner of Friend1 Profile, or the system may be structured that the owner of the ad code gets compensated in full no matter which page the ad code is displayed upon. If the original USER/BROWSER (100) clicks on the friendqadcode (116) on the top of the page (191), the owner of friend1profile (191) will be compensated. Again, the revenue may be shared with the owner of Talent1Profile, or the system may be structured to reserve the revenue for Friend1Profile.

The system may be set up for pay-per-viewing of banners, pay-per-clicking of banners, or some combination thereof. The simple and direct rotation of banners as embodied by TALENT1PROFILE owning all three banners (195), (111), (110) on the original node (190) that the user (100) happens upon, owning the lower two banners (117), (122) on the secondary node the user/browser (100) traverses (113) to, and owning just the bottom ad (129) on the third node (192) the user/browser (100) traverses (119) to represents a most simple and natural manner to rotate banners in a social network so as to compensate both the talent and their friends. Many variations on the basic spirit of this theme may be contemplated and realized by those skilled in the art of web and database design, ad serving, and ecommerce.

Furthermore, should the original web surfer/user/browser (100) visit (119) one of Friend1's (108) friends, say Friend2's (120) profile page (192) in step C (124), again she (100) will be shown three ads on Friend2's page; the top ad (125) will display an ad with Friend2adcode belonging to the creator of friend2profile(192), the side ad(126) will display an ad with Friend1Adcode, and the bottom ad (129) will still be talent1adcode, belonging to the creator of the original talent1profile page (190).

So it is that the primary page's (190) owner, their friends (108) (109), and their friends' friends (120) (121) may naturally be compensated by a sharing and rotation of adspace reflecting the underlying social network—the inherent information contained in the social network.

So it is that the more friends a user has, the more they will be compensated. Both when surfers leave the primary page to visit a friend, and when surfers who happen upon a friends' page leave the page to visit the primary user will result in enhanced chances for compensation.

The more highly the talent ranks in his friends' networks, the more clicks the talent's page will receive, and the more the talent will be compensated. The more people who come from outside of the network to the talent's page, the more the talent will be compensated, meaning that those talents who naturally drive more traffic to the site from external sources will be compensated in greater manners.

This hitherto unseen method in FIG. 1 for rotating ads in the context of a talent database and/or social network will provide new motivation to talent to build high-quality pages with high-quality networks of friends.

This hitherto unseen method for rotating ads in FIG. 1 in the context of a talent database and/or social network mines the social network for its natural value, and lets those building the social network share in its revenue generation, thusly leading to social networks of higher quality.

This hitherto unseen method for rotating ads in FIG. 1 in the context of a talent database and/or social network compensates the talent in a novel and improved manner, paying them both for their talent and their ability to build a network. This hitherto unseen method for rotating ads in FIG. 1 in the context of a talent database and/or social network may be extended to agencies, talent aggregators, and fans, who build out social networks amongst the talent. Or, the methods disclosed in this invention may be reserved only for pre-approved talent in other embodiments.

The method for rotating ads and sharing revenue in FIG. 1 not to be limited to the above discussed algorithm. Multiple algorithms for ad rotation may be explored and used. Other numbers of ads may be used, ranging from 1 to n. Probabilistic or percentage algorithms may also be introduced. Tiered probabilistic or percentage algorithms may also be introduced. For instance, when a user (100) is browsing the content on the primary page that they land on (190), they will see 100% of the primary user's ads—i.ee ads with the primary talent1profile's adcode as shown in (195), (111), and (110). Then, when the user/browser(100) surfs (113) to one of the primary talent1profile's (190) friend's (108) sites (191), they may see 50% of the primary user's ads, and 50% of the new friend's ads, either determined by random probabilities or a straight percentage. The top (116), middle(117), and bottom ads(122) may be served with adcodes belonging to both the primary user talent1profile (109) owning the original node (190), and the friend1 (108) owning the currently viewed profile (191) the user (100) has surfed (113) to. Then, when the user (100) surfs (119) to one of the primary users' (190) friends' (120) friends (192) sites, they may see 25% of the primary user's ads, 25% percent of the friend's ads, and 50% of the friend's friend's ads, which may also be displayed via some randomly determined percentage, weighted in the above manner.

The novel method for rotating ads and sharing revenue in the above social network is not to be limited to the above discussed algorithm. Multiple algorithms for ad rotation and revenue sharing across a social network, based on the abstract premise of this novel concept, may be explored and used.

The premise of this invention is that users and creators of profiles in talent agencies and databases and social networks ought to be afforded maximum opportunities to participate in the wealth generated by talent, as well as talent databases and the labor of creating social networks. When this happens, superior talent databases will result, and superior social networks will result, empowering the talent, the surfers, the consumers, the builders of the talent networks, and the owners of the talent networks as never before.

The premise of this invention is that the talent and users and creators of talent agencies ought be afforded an opportunity to participate in the wealth generation of talent agencies. When this happens, superior talent agencies will result, empowering the users, the talent, the surfers, and the owners of the networks.

The ads in the above example could be linked directly to merchandise sales, either from external merchants, from other members of the talent, or to a unique brand owned and operated by the 45 Talent Agency. In such a case, the ads would represent affiliate relationships, and the compensation could be shared in the above described schemes as well as other schemes, as the ads are rotated in the above described schemes, as well as other schemes.

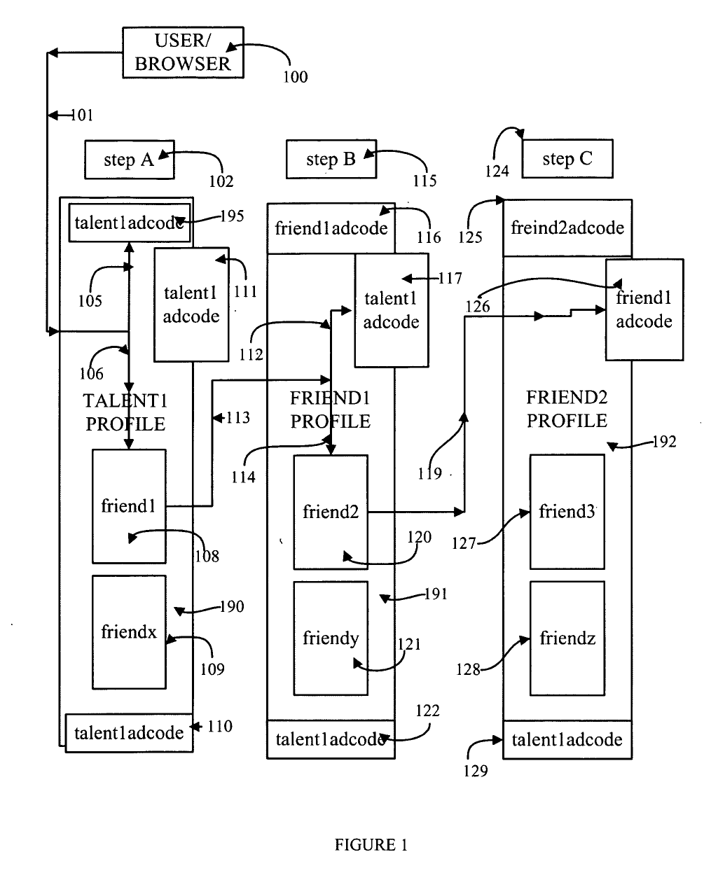

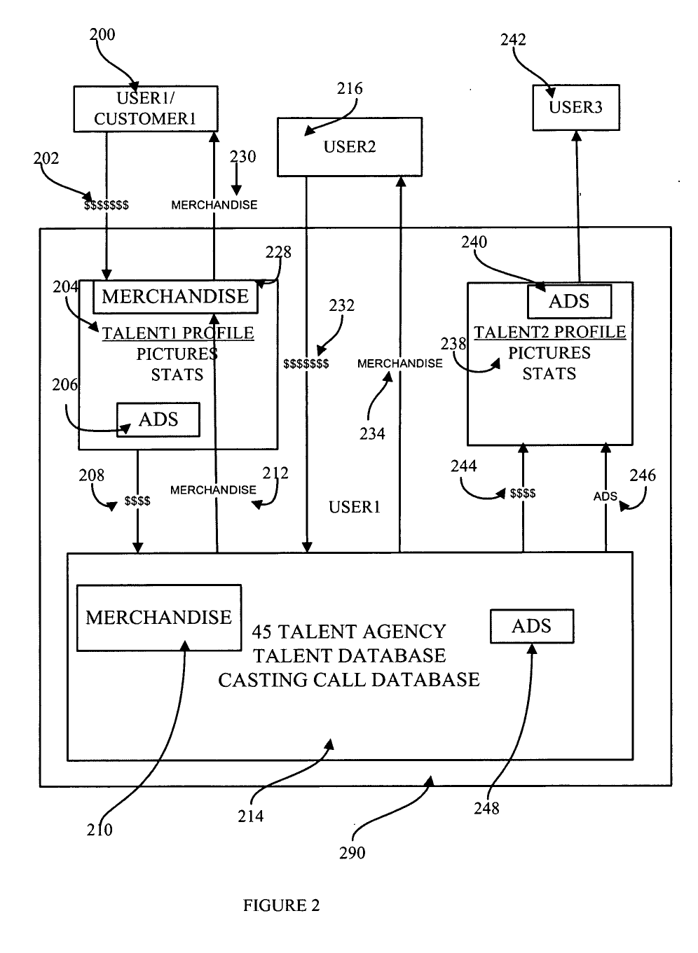

### Detailed Description of FIG. 2:

FIG. 2 shows how a talent agency or database could be easily married to merchandise, a brand, products, and advertising. USER1 (200) browses the Talent1 Profile (204) served by the 45 Talent Agency(290) database (214). The profile offers links to buy merchandise (210) stocked by the 45 Talent Agency (290). The merchandise could be clothes, watches, shoes, or anything else. The owner of the profile (204) could be wearing the merchandise in pictures on their profile (204). The owner of the profile (204) may have to apply to become an affiliate seller of merchandise (210), or they may be able to sell it as soon as they join the Talent agency (290). At any rate,m the original user1 (200) buys the merchandise (202) which was displayed in ad (228) where the talent may be wearing or promoting it, or where it may just be an ad for the merchandise(210). The merchandise(230) is delivered to USER1, the talent who owns profile (204) is compensated, and the rest of the money (208) goes to pay the talent agency (290).

User2 (216) buys merchandise directly from the talent agency (234), in which case the agency gains the full proceeds (232).

User3 (242) sees ads in talent2's profile (238), and the owner of talent2's profile(238) is compensated for the ads displayed and served (246) either by the talent agency (290) or some external body. The Talent Agency (290) may also be compensated for ads served on the user's profiles, and profits from the ads served may be shared.

Another case for FIG. 2 is that when the owner of Talent1 Profile (204) is accepted into the network, they are afforded the opportunity to buy the merchandise (210) at wholesale prices (208) and sell it to their customers (200) at retail prices. So it is that everyone in the talent network can sell the clothes or merchandise, wearing it, and thusly marketing and defining the brand while profiting in the growth of both the brand and the talent agent.

The systems described in FIG. 2 may be improvised upon in multiple ways, while still falling well within the spirit and scope of the present invention. The systems in FIG. 2 may be combined with the systems in FIG. 1, resulting in a rocking, novel system for allowing the talent to prosper, as well building enhanced talent databases, more profitable talent databases, and more profitable and superior social networks.

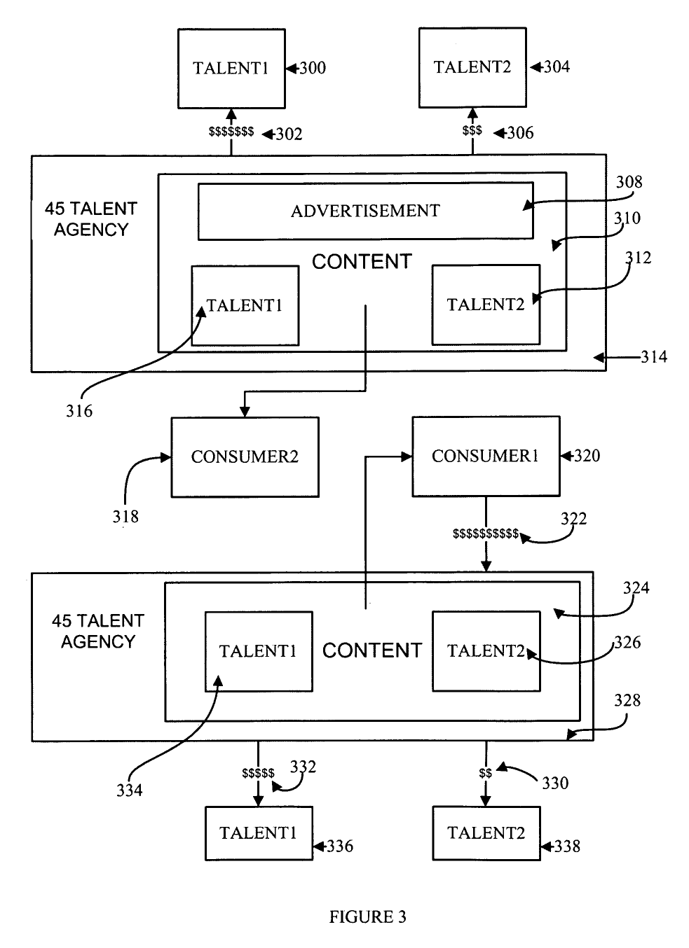

### Detailed Description of FIG. 3:

FIG. 3 presents a method and system allowing the talent to tag content in a manner reflecting the various levels of contributions to the content, and ownership of the content.

Talent1 (316) and Talent2 (312) collaborate in creating content (310). They tag the content as such, representing that each one shares an ownership in the content, with talent1 (316) having a greater ownership, and talent2 (312) having a lesser ownership. When a consumer(318) of the content(310) views the content(310) and an ad is served (308) associated with the content (310), the ad revenue is split proportional to their ownership, and talent1 (300) is paid more (302), and talent2 (304) is paid less(306), commensurate with their respective ownerships.

In the scenario centered about Consumer1(320), Consumer1 pays (322) to view the content (324). Again, talent1 (336) contributed more to the content(324) and thus is paid more (332), while talent2 contributed less to the content(324) and is paid less(330).

One could imagine scenarios that naturally extend the scenarios in FIG. 3 to content that is created by multiple talents and creators, and/or owned by multiple creators, agencies, and entities. And too, one could see that the method and system in FIG. 3 could be a way of solving the “fair use” dilemmas, by fairly compensating talent and creators when their works are used by others.

In such a light, where the creators and talent are compensated maximally, DRM becomes not such a bad thing, and arming all of the talent with the 45 Revolver disclosed in previous patent applications would pave a new way to a new day, whence artists and creators and talent are again compensated for their talent, art, and creations. Even DRM that was unlocked by advertising would be a good thing, especially in the top half of FIG. 3, where the proceeds would be share equally amongst the creators of the content.

The present net is largely the creation of old media companies and postmodern lawyers/MBAs with family-destroying and wealth-transfer tendencies.

Some might say that these patents represent madness. Madness? THIS. IS. SPAAAAAAAARRRTTTTTAAAAAAAAA!!

The rising renaissance needs new systems for protecting and profiting from talent—new systems which better serve the artists—-new systems with classical souls for new art with classical souls. For the pomo-hipster fiat-money class has deconstructed the Epic stories of Moses and Odysseus, and are now attacking property rights; but when they have succeeded, when they have deconstructed every last epic, remade every classic Western in their own image where the good guys die and the bad guys get away with murder, when they have ripped, mixed, and burned every last song on every last CD and given what other's created away for free so they could sell hardware alongside socialism and communism; then shall a new DRM system arise, then shall the man with no name ride back into town, holding his 45 Revolver. As the hedge funds are hedging their bets, they would be wise to not bet against eternity.

A new age has begun-an age of FREEEEEEEEEEDOM!!

http://www.biblebelievers.org.au/usury2.htm reports “The ecclesiastical doctrine of interest was the greatest obstacle to modern banking. It was primarily based upon 1) Aristotle's condemnation of interest as an unnatural breeding of money by money, 2) Christ's (supposed) condemnation of interest (Luke 6:34) and the reaction of the Fathers of the Church against commercialism and usury in Rome. (Will Durant, THE AGE OF FAITH 630, 1950). The moral condemnation of this ancient practice has been summarized: “It comes as news to most people to learn that practically all important ethical teachers—Moses, Aristotle, Jesus, Mohammed, and Saint Thomas Aquinas, for instance—have denounced lending at interest as usury and as morally wrong” (Lawrence Dennis, “The Squirrel Cage of Debt,” Saturday Review of Literature 661, Jun. 24, 1933).”

http://www.biblebelievers.org.au/usury2.htm reports “A long-existing and self-perpetuating tax-immune internationalist-transnationalist group uses fronts with inter-locking corporate and or fraternal group of individuals, whose membership is either secret or semi-secret, with undisclosed ownership shares, has usurped the sovereignty of borrowing national governments (who serve their lenders). It includes largely unrevealed yet reported campaign contributors who also control the media and press, all major political parties, and dictates presidential appointments. It abhors the direct issuance of money by elected officials and through the creation of a system of privately-owned and controlled central banks, holds all of the world's gold and all loan and mortgage paperwork.”

http://www.biblebelievers.org.au/usury2.htm reports “Its business is conducted in secret meetings which determine the future of all national economies and the timing of expansion (through loans) or contraction (through no loans). It exercises an exclusive monopoly of the issuance of money created out of thin air and issued solely as debt, does not create money to repay the interest, and lives off perpetual national debts that consume future income and under international law cannot be repudiated even by an internal political revolution. At least for others, it tends to be pro-bureaucracy, pro-abortion/population control, pro-government education, anti-family, anti-nationalist, anti-inheritance, anti-private property. . . . ” So it is that musicians and artists and models and storytellers have been convinced to hand over their inventions and creations to technology companies and Wall Street, so that the billion-dollar corporations can reap profits from packaging them and selling advertising.

http://www.biblebelievers.org.au/usury2.htm reports “It plans to soon accomplish global disarmament (of both civilians and nations) and have a monopoly on force (including nuclear weapons). It has the privilege of a guaranteed untaxable income enforced by liens on all public and personal property and collected by the coercive force of the taxing structure of the various governments. The basis for its continued existence is continued usury and unforgiving collection of all debts resulting from committing the highest crime of usury.” Dante, Aristotle, the prophets of the Old Testament, and the prophets of the New Testament—all were opposed to Usury. Dante considered it a crime against art; and the present invention goes out to the true creators of wealth and meaning—the artists and entertainers, the poets and prophets.

My domain Starbuck.com™ was recently stolen in an international criminal heist, but I will get it back. For the site was dedicated to the spirit of the Great Books and Classics, from whence the name Starbuck derives, coming from the first mate of the Pequod—Captain Starbuck—a good Quaker. The criminal thieves destroyed this page, http://starbuck.com/military/chat/armychat/searchandys.php, “United States Marine Corps PEN PALS: UNITED STATES ARMY PENPALS,” and they even copied my name BeaconRay™ when they stole it, and put it on the record in Hong Kong. On the starbuck.com™ site, I wrote, “The Starbuck Classical Poetry Port was inspired by a mystical memory which has haunted me ever since this foggy May night by the Corolla Lighthouse, which can be found just North of Duck, on the outer banks of North Carolina. The Lighthouse can be found there, while the memory resides here. Hoping to climb the spiral stairs in the Corolla Light, Misty and I had hopped the criss-cross wooden corrale fence so as to see if the door to the Light was unlocked. Not only was this a first date with a totally awesome girl, but it also happened on that same gothic night that I was introduced to Moby Dick. Now a lot of people might contend that Moby Dick is a novel, rather than a poem, but as of late I have been staying up to all hours of the morning studying the subject, and I say that Poetry is the music of the rational soul, the ultimate expression of the spirit's reality, and a mirror of the intangible, phantasmal essence of our existence. Poetry is found in all the magnificent works which define the fundamental words at the foundations of all our laws, convictions and conventions, our morality, our conscience, and our sense of divinity. Shelley himself declared that poets are the unacknowledged legislators of mankind, and I contend that one can find no noble milestones in history which were not preceded by the spoken or written work of an individual who had the courage to render a bold new vision in words. Though it is often endowed with rhyme and meter, poetry derives its everlasting glory from the depths of the profundities it preserves. Thus the classical poets, who we shall dedicate all the Classicals Inc. websites to, range in character from Shakespeare, to Plato, to St. Augustine, to Thomas Jefferson, to the Prophets, to Herman Melville, to Kipling, to Salinger. And though lacking corporeality, all Great Poetry is as solid and permanent as the rock of the eternal soul. As all noble actions are preceded by thoughts, and all thoughts reside in words, so it is that our freedom, character, and divine sense of meaning derive from language and literature. The Gospel of John presents a brief history of God's aspect and language, which are forever wedded: In the beginning was the Word, and the Word was With God, and the Word was God. The same was in the beginning with God.” And so the Renaissance Shall Be.

### FURTHER OBJECTS AND ADVANTAGES OF INVENTION

All the above systems and methods disclosed in the descriptions and drawing may be enhanced by the 45 Revolver, as introduced alongside Clint Eastwood in Sergio Leone's Fistful of Dollars. Watch the film, and you will understand the Spirit of the Law. An additional Novelty of this Talent agency and online talent database is that it would be embedded with the 45 Revolver, which is elaborated on in patent application #20070156594. Every actor or actress, every graphic designer or musician, every artist or creator—every talent—would be handed a 45 Revolver:

### The 45 Revolver Revisited

Imagine a software application that allowed Kid Rock to sell his music online. That set his mind at ease that he wouldn't be ripped off. Imagine a software application. Identical to the one used by Kid Rock. That allowed you to sell your content online. That set you mind at ease that you weren't being ripped off.

Downhillbattle.org, Kid Rock, David Byrne, Weird Al, Slashdot, and many others all point to the hoax that is iTunes, which actually compensates artists less than traditional CD sales, which factored in the costs of printing, encasing, packing, shipping, wholesaling, and retailing. The true beauty of the internet—connecting the talent and their fans, while eliminating the middleman—is yet to be realized. The 45 Revolver, and the 45 Talent Agency, take us a step closer. Check out Kid Rock's words at http://youtube.com/watch?v=qtzMhWU9DA0 when he appears on the The Hour with George Stroumboulopoulos to talk about his new album Rock N Roll Jesus. Check it—yo.

Imagine a software application. That allowed you to upload your content. And define your rights. That prepared your content for its long voyage throughout the web. That tagged it, so that it always knew the way on back to your home port. To your brand. To you—the creator. That made sure you were compensated as you saw fit.

Imagine a software application and talent agency, that allowed you to upload your headshots, your mp3's, your video, your pdfs, your photographs. Your books and novels. Your movies and documentaries. That watermarked them all. As you saw fit. That thumbnailed them all. As you saw fit. That encrypted the ones that you wished to be encrypted. That allowed you to choose between Microsoft DRM, or Google DRM, or Open Source DRM, or Adobe DRM, or any other DRM; or allowed you to choose every DRM.

Imagine a software application and talent agency that converted your files into andy and every format you wanted, so as to obtain maximum reach—into quicktime, into Windows Media, in Real Media. If you wanted it to. Imagine a software application that allowed you to syndicate or upload your content, or thumbnailed versions of your content, or watermarked versions of your content into portals and marketplaces all about the world. With a single click. Or two. Into pbase.com, deviantart.com, smugsmug.com, flickr.com, facebook.com, myspace.com, turbosquid.com, youtube.com, and lulu.com. Into open source content management systems such as postnuke, joomla, and drupal, and ecommerce systems such as oscommerce, creloaded, and zencart.

Imagine a software application that began with the creator. And focused on the creator. And empowered the creator. And enriched the creator. As never before. That allowed new creator-centered business models to emerge.

Imagine a software application. That achieved the commodity reversal. That viewed the creator as unique and the plethora of digital marketplaces, content management systems, content portals, social networks, and digital media archives as the commodity.

For there are many of them. But only one of you. Only one photo like that photo. Only one song like that song. Only one Story like that Story. They have been telling you that Story does not matter and that art and media are not worth owning, as they replace Story with hype and build vast empires upon the backs of the serfs—the content creators. They have been treating you like a commodity—the owners of myspace.com, flickr.com, lulu.com, amazon.com, and google.com have been growing vastly wealthy.

From your content. They offer good services. Use them for publicity. And distribution. But always be building that brand, and bringing people back to your home port.

The 45Talent Agency embedded with the 45 Revolver is novel. In all the prior art never has there been a software application that seeks to offer the creator a full suite of DRM tools, media formats, and full syndication on out to multiple applications and portals. The 45 Talent Agency, embedded with the 45 Revolver is nonobvious. Many experts state that DRM is bad. For instance, David Byrne of the Talking Heads recently listed ways the artists—who must put the interests of the telecoms, freetards, hardware manufactures ahead of their own—could make money, and he makes no mention of DRM, as DRM is was deemed uncool by the lawyers, MBAs, and suits controlling the billion-dollar industries based on the killing of the Western soul and the replacing of wisdom and knowledge with information and groupthink. Multi-billion dollar corporations, supported by the fiat dollar, oppose DRM, property rights, the traditional family, motherhood, and childhood, because it raises their bottom line while giving freetards some free music, all that the expense of the indie poet and artist—the traditional and preferred enemy of the State. The Wired which contains Byrne's surrender to the Government and Corporate Powers can be found at: http://www.wired.com/entertainment/music/magazine/16-01/ff_byrne?currentPage=all. Other experts state that DRM is impossible. Other experts focus on proprietary DRM schemes that lock users into iTunes or Microsoft formats. But none of the experts have ever sought to solve the DRM problem by offering artists a full spectrum of digital rights management tools, and letting them choose. And not only will this empower creators, but it will empower consumers, as it will be easier to purchase devices that will be guaranteed to work with the Artist's media over time, even changing over time as necessary, and allowing the content and media to be launched into the world in multiple forms.

The 45 Talent Agency, embedded with the 45 revolver, will be useful. By empowering artists, authors, and inventors, it will encourage creativity and innovation, thereby enriching the greater culture. The 45revolver will support brand new kinds of social networks, including 22rock which offers content marketplaces riding upon an underlying social network. The 45revolver and 22rock social network will support brand new kinds of online gaming, where creators, managers, and users will sign up as record label executives, talent managers, and more, and build marketplaces and brands by inviting other users, creators, and content into their networked marketplace. And participants will be compensated when content is sold according to a tiered commissions structure based upon the underlying social network by which the content is linked. Browse the web—myspace.com, flickr.com, lulu.com, amazon.com, home pages, open source cms systems, and what's missing is a way to protect, watermark, encrypt and thumbnail content in a consistent manner. For this reason, vast amounts of labor must be invested by the creator to get their creations out there. Furthermore, their brand is diluted as their homepage is always lulu.com/creator or flickr.com/creator or pbase.com/creator as opposed to creator.com.

The 45 Revolver in the 45 Talent Agency watermarks the media before sending it throughout the web's leading portals, so that the home page creator.com is always emblazoned on the photograph or in the opening scenes of the video, along with any other information the creator wishes to add.

The 45revolver realizes the spirit of the US constitution as never before upon the WWW.
The Congress shall have Power to promote the Progress of Science and useful Arts, by securing for limited Times to Authors and Inventors the exclusive Right to their respective Writings and Discoveries; —The United States Constitution, Section 8, Clause 8

Surf the web and you will see talent databases of artists and models and creators yearning to prosper upon the new digital frontiers. You will hear game developers seeking to own what they do; you will hear musicians seeking to profit from their songs; you will hear photographers on pbase.com and flickr.com seeking to protect their intellectual property and profit from it, so that they can create more.

The 45 Talent Agency, embodied with the 45revolver, will manifest itself as a portal. The first portal on a piece of contents voyage on out. Game creators will use it. Photographers will use it. Musicians will use it. Artists will use it. They will use it before populating other sites with their content.

The 45 Talent agency, embedded with the 45 Revolver, will not replace other portals, but it will provide a different, much needed service. It will first and foremost provide a full suite of DRM tools, watermarking tools, and syndication tools. It may also provide ecommerce tools and social networking tools.

When an artist logs in they will define simple information, such a their name, email, address, paypal address, default price, default rights, and preferred method of payment. Drop-down menus will afford a full spectrum of rights, including creative commons and proprietary rights. Other drop down menus will afford a full spectrum of detination portals, including myspace, flickr, youtube, and 22rock.

Lulu.com wants to keep your content in the lulu.com format. Cafepress wants to keep your content in the cafepress.com format. When you upload to google video, google video want you to use Microsoft DRM. When you upload to flickr, it's tought to get your photos and albums into pbase or the open source gallery. When you upload into pbase, it's tough to get your photos into lulu or gallery or oscommerce.

The 45 Revolver wants to empower artists with maximum protected distribution. The 45 Revolver will begin with the leading open source applications, and then seek to create interfaces with other portals that wish to join the 45 revolver renaissance. Some of them might not for various reasons, but then users of the 45revolver will use the portals and marketplaces and archives that do.

A stand alone digital rights management application and/or portal devoted to offering a full spectrum of DRM options represents a paradigm shift towards a creator-centric web. Too often creators are treated as widgets by corporations and ignorant technophiles and lawyers and MBAs incapable of defining their rights for the content they create. Such a mentality is inherent in many aspects of our society, and it is often used as a wedge to separate a creator from their natural rights and their content.

The 45 Talent Agency, in the spirit of the Constitution's second amendment, realizes that the best way to protect against a feudal system where creators have reduced rights and see little profits is to arm everyone. For as the framers realized, although the pen is mightier than sword, the right to free speech is worth little without the right to bear arms.

The 45revolver talent portal would seek to link to all the best resources—uspto.gov, bzifilngs.com, hostgator.com. Unlike other content portals, the 45revolver portal would not seek to isolate ethe creator's content and hide better deals and better ways of selling the content, but the 45revolver would encourage users to find the best portals, archives, and marketplaces for their content, ranging from do-it-yourself hosting to social networks such as flickr. Users would be told about cafepress.com, iuniverse.com, lulu.com, an dlightningsource.com, and given the instructions and tools to upload their content into any of them.

Imagine a talent agency—the 45TalentAgency—embedded with a software application—the 45 Revolver—that treated each piece of content you created like a person. Every piece of content has its own identity. It has its own lifetime, which in the digital world may tend towards eternity. It has its rights. Content is a multi-trillion dollar business. Digital content can work long and hard—it can work 24/7 year round. Imagine a software application which made sure your content got paid for its work. Any time someone on yahoo or flickr or pbase or google or happened on your web page viewed it and enjoyed it, you got paid.

So it is that certain manifestations of the spirit of the present invention have been described. Many more manifestations could easily be imagined and built by those with basic skills in the field.

What is claimed is:

1. A talent database, affording talent the ability to upload profiles and content, and affording talent seekers the ability to upload casting calls, and allowing both talent seekers and talent the ability to browse profiles, listings, casting calls, and content and the ability of talent to make profits from their profiles and or content and media,

2. wherein said talent database in claim 1 is accessible online

3. wherein said talent database in claim 1 allows the talent and members to protect and profit from their said profiles and content by displaying ads around their profiles and content

4. wherein said talent database in claim 1 allows talent to protect and profit from their said profiles and content by sharing in revenue from ads displayed around their profiles and content.

5. wherein said talent database in claim 1 allows talent to protect and profit from their said profiles and content by displaying ads for merchandise around their profiles and content.

6. wherein said talent database in claim 1 allows talent and members to protect and profit from their profiles and content by selling merchandise or driving merchandise sales by linking to ecommerce systems from their profiles and content.

7. wherein said talent database in claim 1 is associated with a brand of merchandise, and talent and members of the database are allowed to model and promote said brand of merchandise, modeling and promoting said brand of merchandise in scenarios including but not limited to photographs, music, and video

8. wherein said talent database in claim 1 is associated with a brand of merchandise, and certain talent is chosen to represent and sell said merchandise, and certain talent is sold said merchandise at wholesale costs, whereupon they can sell it to their friends at retail

9. wherein said talent database in claim 1 is married to a social network

10. wherein said talent database in claim 1 is endowed with a novel advertising rotating system that displays banners in a manner intrinsically linked to the connections between profile pages,

11. wherein said novel advertising rotating system in claim 11 presents all the ads on a given page or profile associated with the owner of the page or profile when a user happens on the page or profile from an external link, and where ads throughout the various profiles are presented in a manner depending upon the node upon which the talent database was first accessed, and rotated in accordance with how the profiles of the talent database are traversed, displaying ads associated with each node on subsequent nodes, both immediately subsequent nodes and/or nodes traversed further on down the line, in the spirit that the owners and builders of the nodes are profited.

12. wherein said novel advertising rotating system in claim 11 displays ads that represent an affiliate system wherein the ads, carrying affiliate codes, are linked to good and services and an ecommerce engine, in the spirit of profiting the talent who drives the traffic and the talent that directs the traffic on towards the purchase.

13. wherein said novel advertising rotating system in claim 11 displays ads that are text ads or banner ads or video ads relevant to the content on the page or profile

14. wherein said talent database in claim 1 affords all the talent a full suite of watermarking tools, digital rights management options, ecommerce options, and methods and means for sharing, selling, and syndicating their content; and protecting and profiting from said content.

15. wherein said talent database in claim 1 would also provide legal contracts and release forms useful to talent being hired or those hiring talent

16. wherein said talent database in claim 1 requires the talent to promote specific branded merchandise on their pages and in their profiles, including media such as pictures, photographs, video, music, and more.

17. A system for defining and tagging rights of a plurality of talent in a digital piece of art, being it a film, song, picture, video or some other combination, in such a manner that the various talent appearing in the said work of art are compensated fairly and justly in proportion to their contributions to the said work of art, and the revenue generated from ad sales associated with the art, as well as purchases of the art.

18. Wherein the compensation in claim 19 is defined by the various individuals representing the talent coming up with sharing schemes and percentage breakdowns that revenue generated from the said digital piece of art are split amongst the talent.

19. Wherein said system in claim 18 is a universal system extending throughout all networks and devices, making sure that the talent is always compensated by ad sales or media sales whenever the media is viewed or purchased anywhere in the universe.
